(19) United States
(12) Patent Application Publication
(10) Pub. No.: US 2026/0092596 A1
(43) Pub. Date: Apr. 2, 2026

(54) COMMUNICATING FLUID VESSEL ENGINE SYSTEMS

(71) Applicant: James D. Rudd, Key Largo, FL (US)

(72) Inventor: James D. Rudd, Key Largo, FL (US)

(21) Appl. No.: 19/410,827

(22) Filed: Dec. 5, 2025

Related U.S. Application Data
(63) Continuation-in-part of application No. 18/964,202, filed on Nov. 29, 2024.
Application No. 18/964,202 is a continuation-in-part of application No. 18/766,314, filed on Jul. 8, 2024, now Pat. No. 12,372,066.
Application No. 18/766,314 is a continuation of application No. 18/273,712, now Pat. No. 12,037,988.
(60) Provisional application No. 63/144,729, filed on Feb. 2, 2021.

(51) Int. Cl. F03G 3/06; F01D 15/10; F03B 17/02; F03B 17/04; F03B 17/06; F03G 3/00; F03G 7/08; F03G 7/10

(52) U.S. Cl. CPC F03G 3/06; F01D 15/10; F03B 17/025; F03B 17/04; F03B 17/06; F03G 3/096; F03G 7/08; F03G 7/104; F03G 7/107; F05D 2220/76

(57) ABSTRACT

The engine system with communicating fluid vessels has an interconnecting lever conduit configured to rotate about an axis. A first fluid container is fluidically connected to the interconnecting lever conduit and positioned at or near the axis. A second fluid container is fluidically connected to the interconnecting lever conduit and positioned at or near an end of the interconnecting lever conduit. Liquid fluid is movable between the first and second fluid containers through the interconnecting lever conduit. The interconnecting lever conduit with the first and second fluid containers is rotationally balanced about the axis. A shift of fluid mass between the first and second fluid containers rotates the lever about the axis, thereby generating an energy output.

### CROSS REFERENCE TO RELATED APPLICATION

This application is a continuation-in-part of U.S. application Ser. No. 18/964,202 filed Nov. 29, 2024, which itself is a continuation-in-part of Ser. No. 18/766,314 filed Jul. 8, 2024, now U.S. Pat. No. 12,372,066, issued Jul. 29, 2025, which itself is a continuation of U.S. application Ser. No. 18/273,712 filed Jul. 21, 2023, now U.S. Pat. No. 12,037,988, issued Jul. 16, 2024, which is a National Stage Application Under 35 USC § 371 and claims the benefit of International Application No. PCT/US2022/014516 filed Jan. 31, 2022, which claims the benefit of U.S. Provisional Application Ser. No. 63/144,729, filed Feb. 2, 2021, the entire disclosures of which are incorporated herein by reference.

### FIELD OF THE DISCLOSURE

This disclosure relates to systems that produce motion that can be harnessed for useful purposes, such as to generate electricity. For example, this disclosure relates to a communicating fluid vessel system that moves a lever that can drive an electrical generator. The communicating fluid vessel system utilizes changes in the volume, and thereby the weight, of a column of fluid that results from changing of the fluid pressure in one area of the fluid found in a communicating vessel.

### BACKGROUND OF THE DISCLOSURE

Humans have become addicted to fossil fuels for transportation, heat, and to generate power. It is well documented that carbon levels in the atmosphere have been increasing steadily, leading to global warming and the resulting climate change. It is also well documented that the leading cause of carbon level rise is the creation of energy using fossil fuels.

In developed countries, electricity from fossil fuel is cheap and readily available, providing a disincentive to switch to alternative fuel sources. However, the size and complexity of the facility needed for fossil fuel burning energy plants to produce enough electricity prevents such an energy production source from being readily available in poor and underdeveloped countries. These countries suffer from an energy shortage.

Renewable energies such as solar power, wind turbine, and hydroelectric energy alternatives are known in the art. However, these alternatives suffer from the disadvantage that they are still relatively inefficient, expensive to build, and often require specific climate conditions such as wind, rainfall, snowmelt or the like to produce electricity. Such conditions are not readily available throughout the world.

Thus, a heretofore unaddressed need exists in the industry to address the aforementioned deficiencies and inadequacies.

### SUMMARY OF THE DISCLOSURE

Embodiments of the present disclosure provide an engine system with communicating fluid vessels. Briefly described, in architecture, one embodiment of the system, among others, can be implemented as follows. An interconnecting lever conduit is configured to rotate about an axis. A first fluid container is fluidically connected to the interconnecting lever conduit, the first fluid container positioned at or near the axis of the interconnecting lever conduit. A second fluid container is fluidically connected to the interconnecting lever conduit, the second fluid container positioned at or near an end of the interconnecting lever conduit. Liquid fluid is movable between the first and second fluid containers through the interconnecting lever conduit. The interconnecting lever conduit with the first and second fluid containers is rotationally balanced about the axis. A shift of fluid mass between the first and second fluid containers rotates the lever about the axis, thereby generating an energy output.

The present disclosure can also be viewed as providing methods for generating an energy output using an engine system with communicating fluid vessels. In this regard, one embodiment of such a method, among others, can be broadly summarized by the following steps: rotationally balancing an interconnecting lever conduit about an axis, the interconnecting lever conduit configured to rotate about the axis, wherein a first fluid container is fluidically connected to the interconnecting lever conduit and positioned at or near the axis of the interconnecting lever conduit, and wherein a second fluid container is fluidically connected to the interconnecting lever conduit and positioned at or near an end of the interconnecting lever conduit; increasing a pressure in the first fluid container, thereby initiating a fluid chain effect to cause a shift of fluid mass from the first fluid container, through the interconnecting lever conduit, and to the second fluid container, thereby increasing a mass in the second fluid container; using the increase of fluid mass in the second fluid container, rotating the interconnecting lever conduit about the axis, thereby generating a torque about the axis; and outputting an energy output from the torque.

Embodiments of the present disclosure provide an engine system with communicating fluid vessels. Briefly described, in architecture, one embodiment of the system, among others, can be implemented as follows. An interconnecting lever conduit is configured to rotate about an axis. A first fluid container is fluidically connected to the interconnecting lever conduit, the first fluid container positioned at or near the axis of the interconnecting lever conduit. A second fluid container is fluidically connected to the interconnecting lever conduit, the second fluid container positioned at or near an end of the interconnecting lever conduit. Liquid fluid is movable between the first and second fluid containers using the interconnecting lever conduit. The interconnecting lever conduit with the first and second fluid containers is rotationally balanced about the axis. At least one holding tank is positioned in the first fluid container and coupled to a weight positioned at least partially in an outer tank, the outer tank having a fluid therein. At least two tethers are physically linking together the weight and the first fluid container. A plurality of pullies is positioned along a path of the at least two tethers. A supply of a gas is in fluid communication with an interior of the at least one holding tank. Supplying the gas to the interior of the holding tank displaces a volume of fluid from the holding tank increasing the fluid column height of the liquid fluid in the first fluid container which causes a shift of fluid mass between the first and second fluid containers which rotates the lever about the axis, thereby generating an energy output.

Embodiments of the present disclosure provide an engine system with a communicating fluid vessel. Briefly described, in architecture, one embodiment of the system, among others, can be implemented as follows. The engine system with a communicating fluid vessel, the engine system has a first and second fluid container and an interconnecting conduit. The interconnecting conduit is coupled to the first and second fluid containers and defines a fluid passageway by which the first and second fluid containers are in fluid communication. The first container, second container and interconnecting conduit are sometimes referred to as a communicating vessel. The communicating vessel is connected to a lever which pivotal about an axis. Added to this core of the system making up the invention, that is the lever and communicating vessel, are two sets of components. The first set of components are used as a means to change the fluid pressure in one area of the fluid found in the communicating vessel to shift a portion of the fluid in the communicating vessel to and from the end of the lever using changes in the displacement of a volume of fluid found in the communicating vessel. By combining a holding tank and block which are held just under, and above, the surface of the fluid in one of the fluid containers of the communicating vessel, changes in the volume of air in the holding tank will change the displacement of the fluid which can be used to change the height of the one fluid container with respect to the other fluid container of the communicating vessel thereby increasing the fluid pressure at the bottom of the fluid column with the higher elevation. The fluid column with the higher elevation will shift fluid mass into the bottom of the fluid column with the lower elevation creating additional fluid mass in the fluid column with the lower elevation until equilibrium is again reach and both fluid column surfaces have the same elevation. The second set of components are added as a means to cause the invention to be rotationally balanced by using a rod partially submerged in fluid of the same density to apply force to the lever that changes with changes in the position of the lever.

As will be described herein, the disclosed systems and methods use at least one communicating vessel with at least one lever, which are formed as a rotationally balanced structure. Changes in fluid pressure are used to shift fluid mass in the communicating vessel to one or more fluid containers positioned at the end of the lever when the lever is at the top of its rotation, and also uses changes in fluid pressure to shift fluid mass in the communicating vessel away from the one or more fluid containers positioned at the end of the lever when the lever reaches the bottom of its rotation.

To change the fluid pressure in the communicating vessel, work is introduced into the system, which is denoted as Work Input. For instance, a fluid or gas pump can be used to introduce Work Input. The pump may be used to move a low-density fluid, e.g. air or another gas, to or from a holding tank to displace a volume of fluid, or reduce the displacement of a volume of fluid, at or near the surface of fluid in the communicating vessel and lever. These changes in displacement change the elevation of fluid in one fluid container, when compared to the elevation of fluid in the other fluid container, which upsets the offsetting fluid column pressures inherent in a communicating vessel. The fluid column with the higher surface elevation, and thereby the higher-pressure at the bottom of its fluid column of the communicating vessel, when compared to the other fluid column of the communicating vessel, push toward the lower-pressure fluid column pushing it up and filling in underneath until the surface elevations are the same between the two fluid columns of the communicating vessel.

When it is assumed that the lower pressure fluid column is positioned at the end of the lever, the other fluid column of the communicating vessel is held off of the lever and the structure of the system being rotationally balanced at the outset, the additional fluid mass moved to the end of the lever upsets the rotational balance and rotates the end of the lever with the additional fluid mass, that is additional weight, downward. When the lever reaches a bottom position, e.g., at the bottom of the rotational path, low-density fluid or air can be moved out of the holding tank, which causes the fluid container, not at the end of the lever, of the communicating vessel to take back the additional fluid mass that was moved to the end of the lever at the top of the rotation. Shifting the additional fluid mass moved to the end of the lever at the top of the rotation, back from the end of the lever, returns the system back into a rotationally balanced structure again so that the lever and its communicating vessel can be lifted back to the top of the rotation with less Work Input.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. As such, many of the components of the drawings are shown not necessarily shown to scale in order to provide clarity of disclosure. Moreover, in the drawings, like reference numerals designate corresponding parts throughout the several views.

FIG. 1 is a schematic illustration showing, in general, a front view of an example communicating vessel system.

FIG. 2 is an illustration which shows the set of communicating vessels of FIG. 1 with an example lever overlaying the illustration.

FIG. 3 is an illustration which shows the arrangement of FIG. 2 in another configuration.

FIG. 4 is an illustration which shows the arrangement of FIG. 3 with the lever being the conduit that fluidly interconnects the communicating vessels.

FIG. 5 is a schematic illustration showing a front view of another example communicating vessel system with the conduit that fluidly interconnects the communicating vessels acting as a lever.

FIG. 6 is a schematic illustration showing eight of the one-lever communicating vessel systems of FIG. 5 that are mechanically coupled to operate together.

FIG. 7 is a schematic illustration showing a top view of an example two-lever communicating vessel system in accordance with some embodiments.

FIG. 8 is a schematic illustration showing a front view of the two-lever communicating vessel system of FIG. 7.

FIG. 9 is another schematic front view of the two-lever communicating vessel system of FIG. 7.

FIG. 10 is another schematic front view illustration of the two-lever communicating vessel system of FIG. 7, showing additional components of the system.

FIG. 11 is another schematic front view illustration of the two-lever communicating vessel system of FIG. 7, showing additional components of the system.

FIGS. 12A and 12B are representative diagrammatical illustrations of the relationship between Work Input, Energy Transfers and the fluid chain shift in gaining height in the creation of Vadditional, in accordance with the present disclosure.

FIG. 13 is a schematic front view illustration of a fluid communicating vessel in one position, in accordance with the present disclosure.

FIG. 14 is a schematic front view illustration of a fluid communicating vessel in another position, in accordance with the present disclosure.

FIG. 15 is a schematic front view illustration of a fluid communicating vessel in yet another position, in accordance with the present disclosure.

FIG. 16 is a schematic front view illustration of a fluid communicating vessel with a fluid rod, in accordance with the present disclosure.

FIG. 17 is schematic front view illustration of a fluid communicating vessel using a weight and dual container system, in accordance with the present disclosure.

FIG. 18 is schematic front view illustration of the fluid communicating vessel using the weight and dual container system of FIG. 17, in a rotationally unbalanced state, in accordance with the present disclosure.

FIG. 19 is schematic front view illustration of the fluid communicating vessel using the weight and dual container system of FIG. 17, in a rotationally balanced state, in accordance with the present disclosure.

FIG. 20 is schematic front view illustration of the fluid communicating vessel using the weight and dual container system of FIG. 17, illustrated with an output thereof, in accordance with the present disclosure.

FIG. 21 is a schematic front view illustration of a ganged fluid communicating vessel, in accordance with the present disclosure.

### DETAILED DESCRIPTION

The engine systems disclosed in this document operate using at least two scientific principles in general. The first principle is that of a lever. A lever is a simple machine that takes a small amount of force over a long distance and converts it to a large amount of force over a short distance. The second principle is based upon the behavior of the fluid found in a communicating fluid vessel system. A communicating fluid vessel system includes two or more containers that are fluidly connected at or near their bottoms, that are open to the atmosphere, and that contain a homogeneous fluid.

The nature of a communicating fluid vessel system is that the surface of each fluid column maintains an equal elevation with all other fluid columns of the system. This is a result of nature's propensity to equalize the fluid pressure at common elevations among the fluid columns. Since the fluid pressure of a fluid column open at the top to the atmosphere is linearly proportional to the depth at that point from the surface, a communicating vessel system can remain stable only when the pressure at all elevations of the fluid columns is the same. This also means that the elevation of the top surface of each fluid column within the system is the same.

In the series of figures provided by this disclosure, components of the communicating fluid vessel system described herein are introduced and explained in a gradual manner in order to help the reader gain a clear understanding of each portion of the system. For example, some of the initial figures show only portions of the system in a schematic manner, and then later figures show other portions and the overall system. In addition, some of the figures show particular portions of the system in detail while other portions of the system are excluded from those figures. Accordingly, in such a case the reader can gain an understanding specifically about those particular portions of the system. These techniques for explaining the systems disclosed herein are used to help the reader understand each portion of the systems, and to understand the structure and operation of the overall systems.

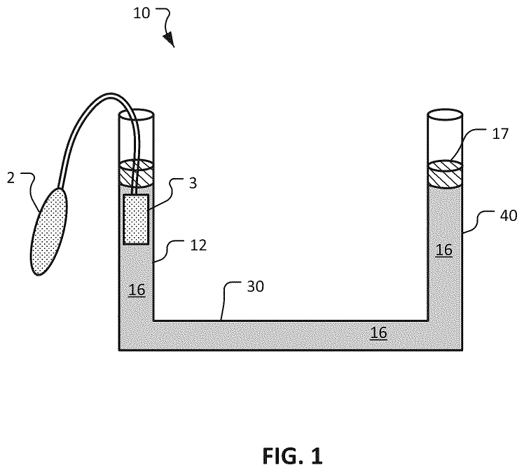

FIG. 1 schematically shows an example communicating fluid vessel system 10 (or simply “system 10”) containing a fluid 16. The system 10 includes a fixed container 12, an outer container 40, and an interconnecting conduit 30. The interconnecting conduit 30 fluidly connects the fixed container 12 to the outer container 40.

Work can be added to the system 10, e.g., by squeezing a bulb or ball 2 to move, by way of a hose, air into a bladder 3 that is held just under the surface of the fluid within the fluid column of the fixed container 12. As the bladder 3 expands, fluid in the system 10 is displaced. Note that the ball 2, hose and bladder 3 are for illustrative purposes only, and are not necessarily part of the invention. The displacement of some of the fluid 16 from the expansion of the bladder 3 increases the fluid column height in the fixed container 12, and by virtue of the interconnecting conduit 30, shifts (displaces) an additional volume 17 of the fluid 16 (with its additional fluid mass) to a higher position, with this process successively repeating until there is an additional fluid 17 mass at the top of previously existing fluid column in the outer container 40. This additional fluid 17 is also referred to herein as an additional volume of fluid 17, new fluid mass 17, or Vadditional 17.

To provide clarity in disclosure, it is noted that the successive shifting of the fluid 16 in the communication vessel may be analogized to shifting links of a chain, with each link shifting a short distance toward the lower pressure fluid column. Vadditional 17 is understood as the fluid mass represented by the top link in the fluid column which was created from an additional volume of fluid mass shifted into the bottom of the fluid column. Vadditional 17 may be understood being represented by the top link lifted a short distance to a higher elevation. Due to a new fluid volume filled in at the bottom of the fluid column, represented as new link of the chain at the bottom, the overall fluid column is now an additional fluid volume (Vadditional 17) taller, represented by an additional chain link in the height in the column, despite the movement to achieve Vadditional 17 at the top of the fluid column only requiring the added work needed to move a single chain link in an otherwise balanced fluid system.

The work added to expand the bladder 3 is approximately proportional to the amount of new fluid mass 17 shifted (displaced) to the top of the fluid column in the outer container 40. Moreover, the work added to increase the fluid column height in the outer container 40 is independent of the starting fluid column height in the system 10 (as long as the depth of the bladder 3 below the surface of the fluid 16 in the fixed container 12 remains the same). The reverse is also true. That is, releasing the contracted bladder 3 can equally decrease the fluid column heights in the fixed container 12 and the outer container 40, independent of the starting fluid column height in the system 10.

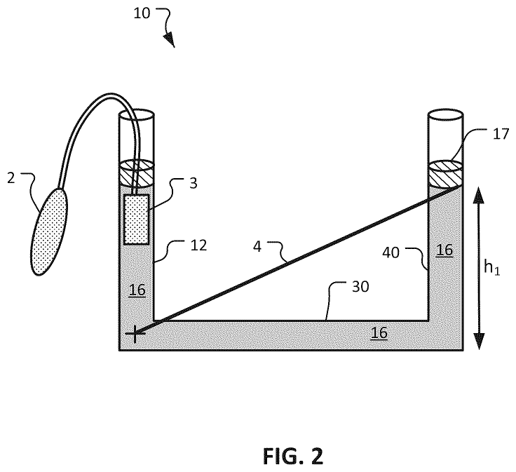

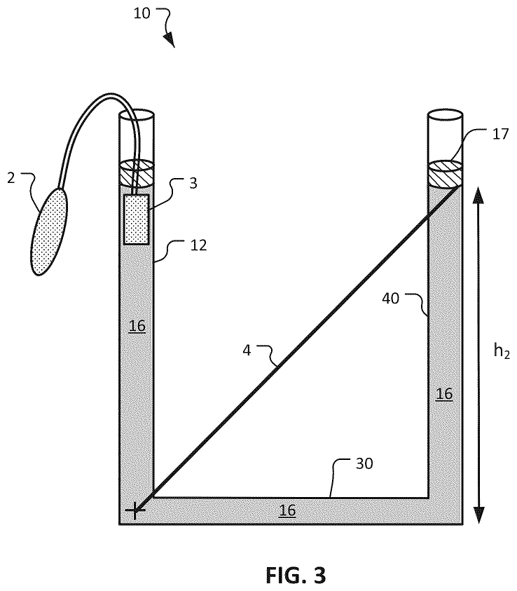

Referring also to the schematic diagrams of FIGS. 2 and 3, the system 10 can also include a lever 4. The lever 4 is rotatably coupled to the base of the fixed container 12 at a first axis. Accordingly, the lever 4 can rotate about the first axis.

FIG. 2 shows the system 10 with the outer container 40 having an initial fluid column height h₁. FIG. 3 shows the system 10 with the outer container 40 having an initial fluid column height h₂. The height h₂ is greater than the height h₁. It follows then, that if we consider only the weight of the fluid mass of Vadditional 17 applied to the lever 4 of FIG. 3 results in a greater torque of the lever 4 about its axis of rotation as compared to the weight of the fluid mass of Vadditional 17 applied to the lever 4 of FIG. 2. This remains true even though the added work required to squeeze the ball 2 to increase the fluid column heights in the containers 12/40 (resulting in Vadditional 17) is the same in both FIG. 2 and FIG. 3.

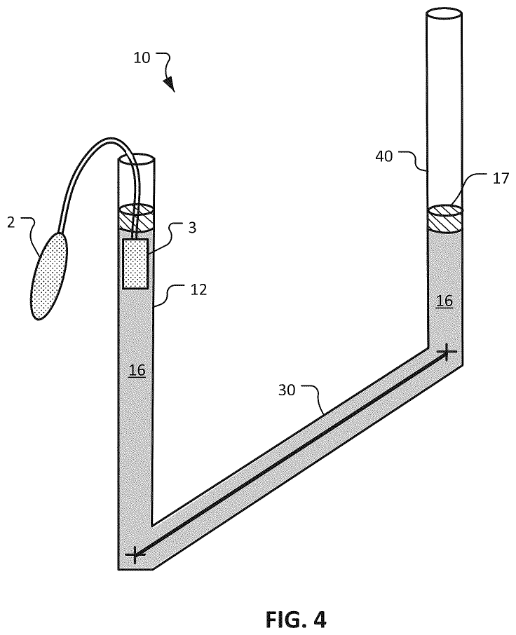

Referring also to FIG. 4, here the interconnecting conduit 30 has been combined with the lever 4 to create an interconnecting lever conduit 30. The interconnecting lever conduit 30 functions not only to fluidly interconnect the containers 12 and 40, but also to act as a lever. A first end of the interconnecting lever conduit 30 is rotatably coupled to the fixed container 12 and the other end the interconnecting lever conduit 30 is rotatably coupled to the outer container 40. The rotatable couplings can comprise rotary unions that allow fluid to flow through the rotatable connections. This arrangement allows the interconnecting lever conduit 30 itself to be used as the lever with the axis of rotation at the bottom of the fixed container 12, and the outer container 40 residing at the outer end of the interconnecting lever conduit 30.

As work is added to increase the fluid column height in the fixed container 12 (e.g., from expanding the bladder 3) the natural equalization of the fluid column pressures in the communicating vessels of the system 10 causes fluid 16 to be displaced, and Vadditional 17 is displaced to the top of the fluid column in outer container 40. With the interconnecting lever conduit 30 together with outer container 40 and its fluid being rotationally balanced and free to rotate about its axis of rotation at the bottom of the fixed container 12, the added weight of the fluid column height in the outer container 40 due to Vadditional 17 causes a torque of the interconnecting lever conduit 30 about its axis of rotation at the bottom of the fixed container 12.

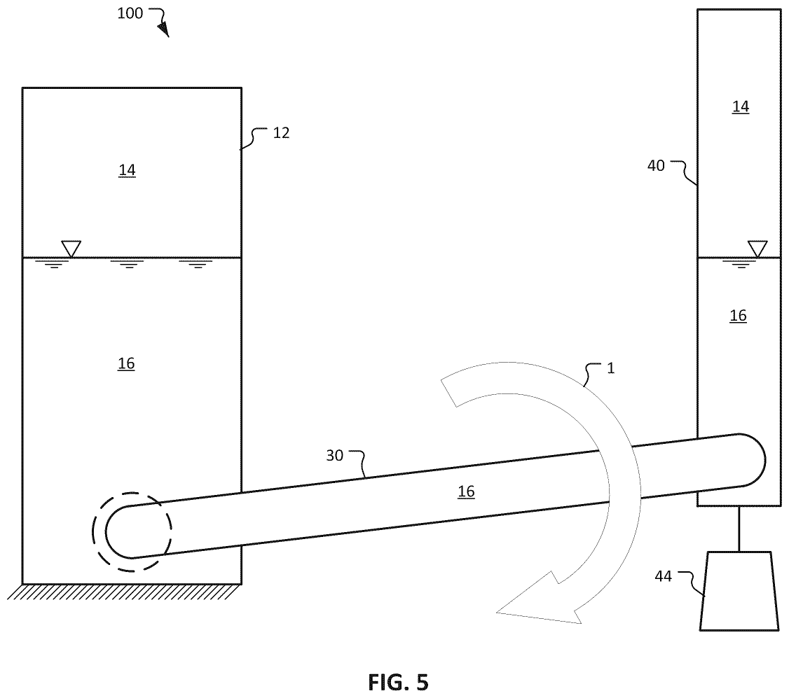

FIG. 5 depicts a communicating fluid vessel system 100 that is analogous to the system 10 described above. There are three main parts of the system 100: the fixed container 12 (containing the fluid 16); the interconnecting lever conduit 30 (containing the fluid 16); and the outer container 40 (containing the fluid 16). The interconnecting lever conduit 30 fluidly couples the fixed container 12 with the outer container 40. The system 100 uses the combined principles of a mechanical lever and a communicating fluid vessel system.

The system 100 includes the two containers (the fixed container 12 and the outer container 40) that are each filled with a homogeneous fluid (the fluid 16). The fixed container 12 and the outer container 40 are in fluid communication with each other via the interconnecting lever conduit 30, are subject to the same atmospheric pressure, and are connected at their bases by the interconnecting lever conduit 30 (which acts as a mechanical lever).

When the fluid 16 is settled in the system 100, the fluid 16 balances out to the same level (elevation) in both of the containers 12 and 40 regardless of the shape and volume of the containers 12 and 40. Naturally, a change in fluid column height in one container will cause an equal change in the fluid column height in all containers of the system 100. However, even though the fluid column heights in all containers of the system 100 change equally, the associated change in volume of fluid in each container will be allocated based upon the fluid surface area of each container. For example, if a first container has twice the cross-sectional surface area of fluid as compared to a second container, the first container will receive double the fluid volume of the second container when fluid is added to the containers.

Still referring to FIG. 5, the fixed container 12 is fixed in space. In some embodiments, the container 12 resides on a stand, a foundation, and the like (not shown). The outer container 40, in contrast, rotates or revolves 360° around the fixed container 12 as indicated by the arrow 1. The circular path followed by the outer container 40 around the fixed container 12 is defined or controlled by the interconnecting lever conduit 30 that fluidly and mechanically interconnects the fixed container 12 and the outer container 40.

The interconnecting lever conduit 30 is multifunctional. That is, first, the interconnecting lever conduit 30 acts as a pivotable mechanical connection between the fixed container 12 and the outer container 40. In that sense, it can be said that the interconnecting lever conduit 30 acts as a lever arm. In addition, the interconnecting lever conduit 30 allows fluid flow therethrough such that the interiors of the fixed container 12 and the outer container 40 are fluidly connected. In that sense, it can be said that the interconnecting lever conduit 30 acts as a hose or fluid conduit.

Since the interior volumes of the fixed container 12 and the outer container 40 are fluidly connected by the interconnecting lever conduit 30, the interfaces between the fluid 16 and the air 14 in both of the containers 12 and 40 are at, and by nature will always be at, the same elevation. Said simply, the level of the fluid 16 in each of the containers 12 and 40 will always be at, or seeking, equal elevations (even as the outer container 40 rotates around the fixed container 12). This is the principle inherent in a communicating fluid vessel system.

Attached to the outer container 40 (or integral therewith) is a weight 44. The weight 44 serves to keep the outer container 40 essentially vertical (as depicted in FIG. 5) as the outer container 40 rotates around the fixed container 12.

A rotary union can be used at the rotatable junction between the outer container 40 and the interconnecting lever conduit 30. Accordingly, as the outer container 40 rotates around the fixed container 12, the fluid 16 can freely pass between the outer container 40 and the fixed container 12 via the interconnecting lever conduit 30, and the outer container 40 can remain essentially vertical.

The orientation of the interconnecting lever conduit 30 relative to the fixed container 12 can be defined in reference to the position of an arm on an analog clock. For example, when the interconnecting lever conduit 30 is extending straight upward relative to the fixed container 12, it can be said that the interconnecting lever conduit 30 (and the outer container 40) is at the 12 o'clock position. Or, when the interconnecting lever conduit 30 is extending laterally (horizontal) relative to the fixed container 12, it can be said that the interconnecting lever conduit 30 (and the outer container 40) is at the 3 o'clock position or the 9 o'clock position (depending on whether the interconnecting lever conduit 30 is extending rightward or leftward from the fixed container 12). This nomenclature (using the clock analogy) will be used hereafter to describe the relative position of the outer container 40 (and the middle container 60) relative to the fixed container 12.

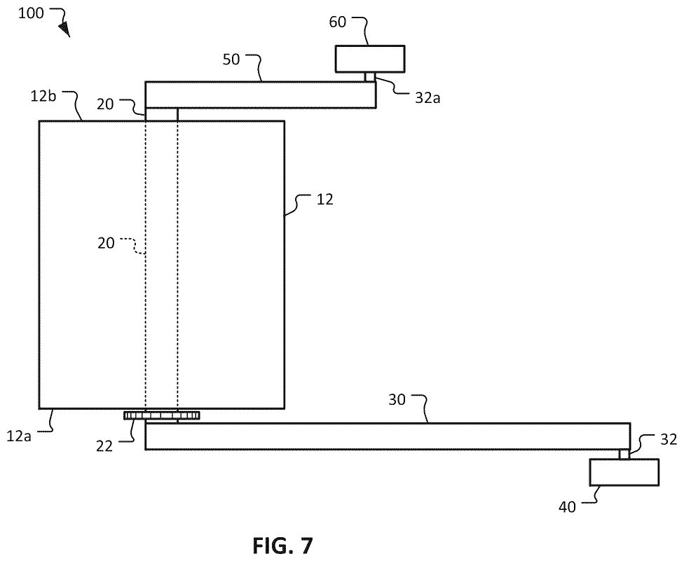

System 100, as described further below, is composed of three fluidly communicating containers: (i) the fixed container 12, (ii) the outer container 40, and (iii) a middle container 60 (not shown here for simplicity, see FIGS. 7-12, for example). All three containers 12, 40, and 60 are open to the environment 14 at the top. All three containers 12, 40, and 60 are closed on their respective bottom and sides. The three communicating containers 12, 40, and 60 are configured to hold a fluid 16, say water. Hereafter in this disclosure, air 14 and water 16 will be used for simplicity sake. It should be understood, however, that other fluids can be used in the system 100 as long as the density of the fluids are differing, and the fluid or material in the upper position, e.g., the location of air 14, is less dense than fluid 16.

As described further below, the core design of the communicating fluid vessel engine systems described herein is that multiple communicating fluid vessel systems (e.g., the system 100) are arranged in the design of a wheel and axle such that the fixed container 12 of each system 100 fixedly resides on the axis of the wheel, the interconnecting lever conduit 30 acts as a spoke in the wheel, and outer container 40 resides on the rim of the wheel. As described further below, multiple outer containers 40 can be equally spaced around the wheel. Each system 100 can be identical, and all can contain the same volume of fluid 16. The wheel and axle design is intended to be rotationally balanced before any displacement of fluid 16 in the fixed container 12 of any system 100.

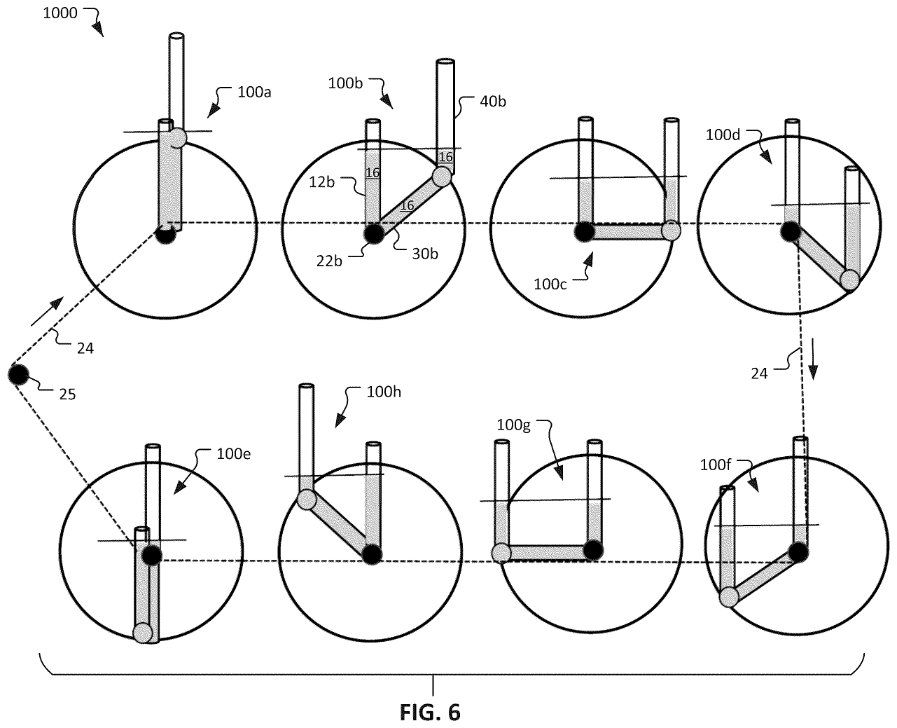

Referring also to FIG. 6, multiple systems 100 can be mechanically coupled together (or ganged together) to create an overall system 1000. In the depicted example, eight systems 100a, 100b, 100c, 100d, 100e, 100f, 100g, and 100h (collectively referred to as systems 100a-h) are mechanically coupled together to create the overall system 1000. It should be understood that, while the depicted example includes the eight systems 100a-h, any practical number of the systems 100 can be mechanically coupled together to create an overall system 1000. For example, two systems 100, three systems 100, four systems 100, and so on, can be mechanically coupled together to create an overall system 1000. In addition, it should be understood that FIG. 6 is a schematic illustration that, for the sake of clarity, does not show all portions of the systems 100a-h. For example, as described further below, the systems 100a-h each include a middle container and other components. Those portions are not shown in FIG. 6 so that the concept of mechanically coupling together multiple systems 100a-h in the manner shown can be understood without obscurity from excessive detail at this point.

The construction of each of the systems 100a-h is the same in this example. In FIG. 6, the exemplary system 100b includes labels for its fixed container 12b, outer container 40b, and interconnecting lever conduit 30b. The system 100b also includes a sprocket 22b that rotates in correspondence with the rotation of the interconnecting lever conduit 30b. It should be understood that the other systems 100a and 100c-h, while not labeled, include the same components as the system 100b.

In this example, sprockets (e.g., the sprocket 22b of the system 100b) are included on each of the systems 100a-h. Those sprockets are each movably coupled to a continuous chain 24. The chain 24 is also coupled to a driven sprocket 25 that is attached to a shaft. The chain 24 drives the rotation of the driven sprocket 25 and its associated shaft. That shaft can be coupled to a generator, for example, for generating electricity. In the depicted example, the chain 24 is moving clockwise. While the depicted overall system 1000 uses the sprockets and chain 24, it should be understood that various other types of power transmission systems can be used (e.g., gears, power transmission shafts, hydraulics, and the like).

In the depicted orientation of the overall system 1000 (which, collectively, is essentially akin to a wheel and axle), it can be observed that the system 100a is orientated in the 12 o'clock position. In addition, it can be observed that the system 100c is orientated in the 3 o'clock position. The system 100b is orientated midway between the systems 100a and 100c.

Accordingly, it can be stated that the system 100b is orientated at the 1:30 o'clock position. The other systems 100d-h are oriented in other positions. For example, system 100d is oriented in the 4:30 o'clock position, the system 100e is oriented in the 6 o'clock position, the system 100f is oriented in the 7:30 o'clock position, the system 100g is oriented in the 9 o'clock position, and the system 100h is oriented in the 10:30 o'clock position. These orientations change (e.g., progress) as the overall system 1000 rotates via the chain 24, but the relative orientations between the respective systems 100a-h stay constant while the overall system 1000 rotates.

To put it another way, the systems 100a-h are incrementally oriented at 45° apart from each other. That is, for example, the system 100b is 45° clockwise in relation to the system 100a. Similarly, the system 100c is 45° clockwise in relation to the system 100b, the system 100d is 45° clockwise in relation to the system 100c, the system 100e is 45° clockwise in relation to the system 100d, the system 100f is 45° clockwise in relation to the system 100e, the system 100g is 45° clockwise in relation to the system 100f, the system 100h is 45° clockwise in relation to the system 100g, and the system 100a is 45° clockwise in relation to the system 100h. These incremental differences of 45° are maintained as the overall system 1000 rotates/operates.

It can be observed in FIG. 6 that the water in the fixed container 12 and water the outer container 40 are at equal elevations in each of the systems 100a-h (no matter what orientation the systems 100a-h are in). For example, referring to the exemplary system 100b, the water 16 in the fixed container 12b is at the same elevation as the water 16 in the outer container 40b. The equal elevations of the water are indicated by the horizontal lines drawn in each of the systems 100a-h. While the elevations of the water in the fixed container and the outer container remain equal, the volumes of the water in the fixed container 12 and the outer container 40 change, even though the total volume of water 16 in a system 100 remains the same.

Referring again to the exemplary system 100b in the orientation depicted in FIG. 6, it can be envisioned that the weight of the water 16 in the outer container 40b and the interconnecting lever conduit 30b will create a clockwise torque at the sprocket 22b that will tend to urge the chain 24 in a clockwise direction. That is, with the outer container 40b and the interconnecting lever conduit 30b being laterally offset from a vertical axis extending through the sprocket 22b, the pull of gravity on the mass of the outer container 40b, the interconnecting lever conduit 30b, and the water 16 therein will generate a clockwise torque at the sprocket 22b.

Referring now to the other systems 100a and 100c-h in the orientations shown in FIG. 6, it can be envisioned that the systems 100c and 100d will also create clockwise torques at their respective sockets. Further, in can be envisioned that the systems 100a and 100e will be neutral (i.e., not generate any torque in the depicted orientation). Still further, it can be envisioned that the systems 100f, 100g, and 100h will create a counter-clockwise torque at the sprocket 22b that will tend to urge the chain 24 in the counter-clockwise direction.

The overall system 1000 (as depicted in its partial form in FIG. 6, which is not the complete form of the overall system 1000) is balanced. That is, in terms of the torques created at the sprockets of the systems 100a-h, every clockwise torque of one system is offset by an equal counter-clockwise torque of another system, or taken together the total clockwise rotational forces from multiple systems 100a-h, should be equal to the total counter-clockwise rotational forces from multiple systems 100a-h, in the overall system 1000. For example, the clockwise torque generated by the system 100b is offset by the equal counterclockwise torque generated by the system 100h. Similarly, the systems 100a and 100e offset (or counterbalance) each other, the systems 100c and 100g offset each other, and the systems 100d and 100f offset each other.

FIG. 7 is a top view of the system 100. The system 100 includes the fixed container 12, the interconnecting lever conduit 30, and the outer container 40 as described above. Now, the middle container 60 and its associated short lever conduit 50 are also shown for the first time.

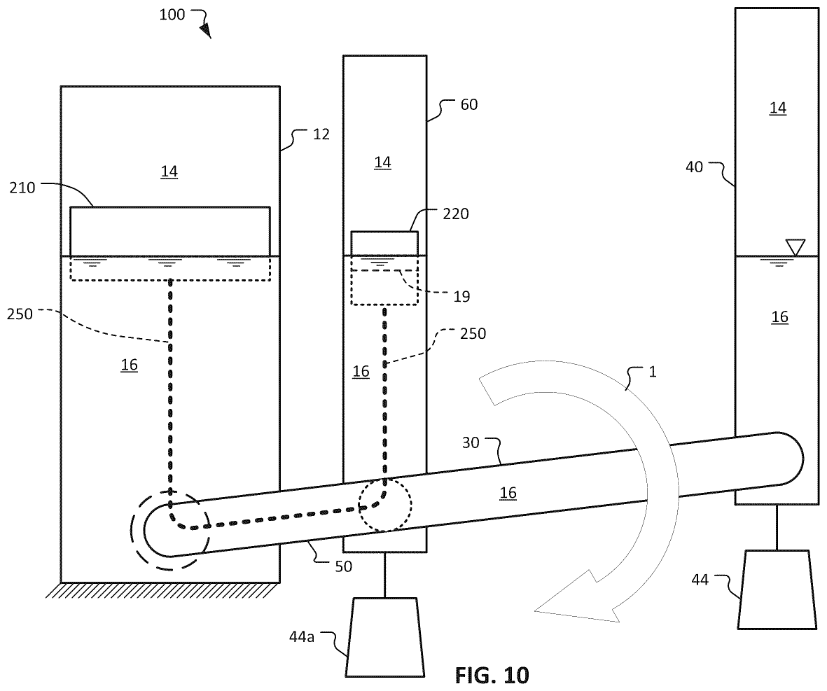

The addition of middle container 60 and the short lever conduit 50 together with the float 210 in container 12 and float or holding tank 220 in middle container 60, which are coupled together by tether 250 (as shown in FIG. 10), are added components to change, and maintain, the fluid pressure in the system 100. The middle container 60 and the short lever conduit 50 function in the same manner as the outer container 40 and the interconnecting lever conduit 30 as described above. However, the short lever conduit 50 is shorter than the interconnecting lever conduit 30, so the middle container 60 is always closer to the fixed container 12 than the outer container 40.

Protruding from the front 12a and back 12b of the fixed container 12 is a tube 20 that resides in the container 12, and is designed to rotate 360 degrees in container 12 without allowing any water 16 to leak out of the fixed container 12. Near the front 12a of container 12, connected to tube 20, is the sprocket 22. Sprocket 22 connects by way of the chain 24 (FIG. 6) to the driven sprocket 25 that drives its associated shaft.

One end of tube 20, on the front 12a of fixed container 12, is connected to the interconnecting lever conduit 30, and the other end of the tube 20, on the back 12b of fixed container 12, is connected to the short lever conduit 50. The design of tube 20 allows water 16 to move into and out of fixed container 12, and into and out of the interconnecting lever conduit 30 and the short lever conduit 50 without any water 16 leaking out of system 100.

The outer container 40 rotates around the fixed container 12 with the central axis of the tube 20 as the pivot point. The outer container 40 remains upright while traveling a complete rotation around fixed container 12 by way of the rotary union 32 and the weight 44. The elevation of the water 16 changes in the outer container 40 as the outer container 40 rotates around the fixed container 12. However, the elevations of the water 16 in each of the three containers 12, 40 and 60, always remain equal to each other.

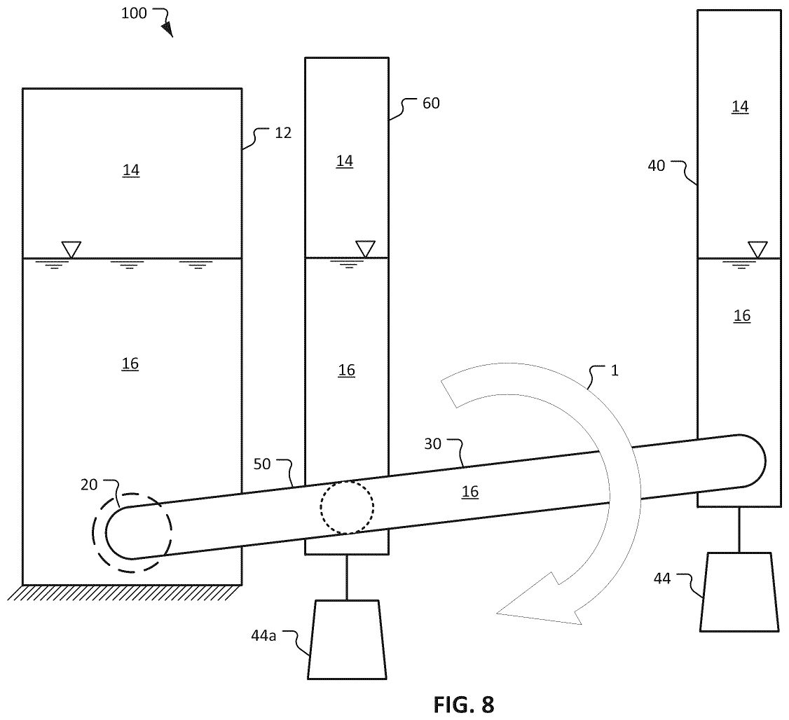

The tube 20 also connects to the short lever conduit 50, and a rotary union 32a connects the short lever conduit 50 to the middle container 60. The middle container 60 is (like the outer container 40) also designed to rotate around the fixed container 12, with the tube 20 acting as the pivot point. Like the outer container 40, the middle container 60 also remains upright while traveling complete rotations around the fixed container 12 by way of the rotary union 32a and a weight 44a (FIG. 8).

System 100 is designed so that the fluid in middle container 60 flows into and out of short lever conduit 50, and into and out of fixed container 12 based upon the position of the middle container 60 relative to the positions of fixed container 12 and the outer container 40. That is, as the middle container 60 rotates around the pivot point of the tube 20, the elevations of the water 16 in each of the three containers 12, 40 and 60, always remain equal to each other.

In the system 100, since it is a communicating vessel system, the elevations of the columns of water 16 in the fixed container 12, the middle container 60 and the outer container 40, always maintain an equal elevation with each other, even though the volume of fluid in each individual container varies as the middle container 60 and the outer container 40 rotate around their pivot points, or axes of rotation, found at the tube 20 of the fixed container 12.

Referring also to FIG. 8, the short lever conduit 50 is connected to the interconnecting lever conduit 30 by way of the tube 20. The angle of rotation and orientation of both the interconnecting lever conduit 30 and the short lever conduit 50 is the same. Accordingly, as the short lever conduit 50 and its middle container 60, and the interconnecting lever conduit 30 and its outer container 40, rotate around the fixed container 12 they are always at the same angular orientation in relation to the fixed container 12. Accordingly, in this illustration the short lever conduit 50 is located out of view behind the interconnecting lever conduit 30.

In the system 100, as the outer container 40 and the middle container 60 rotate from their 12 o'clock positions to their 6 o'clock positions, the heights of the columns of water 16 rise in each container 40 and 60, and the height of the column of water 16 in fixed container 12 falls.

Likewise, as the outer container 40 and the middle container 60 rotate from their 6 o'clock positions to their 12 o'clock positions, the heights of the columns of water 16 falls in each container 40 and 60, and the height of the column of water 16 in fixed container 12 rises. Such is the case because the elevations of the water 16 in each container 12, 40 and 60 are always equal with each other.

Typically, the volumes of the water 16 (and thereby the weights of the columns of water 16) found in the middle container 60 and outer container 40 at each point on one side of their rotation are equal to the volumes of the water 16 (and thereby the weights of the columns of water 16) at each mirror opposite point in the rotation of the middle container 60 and the outer container 40. Or said another way, in a complete rotation of the middle container 60 and the outer container 40 the clockwise rotational forces on the tube 20, equal the counterclockwise rotational forces on tube 20 (as was also described above in reference to FIG. 6).

It is understood that using a smaller number of system 100s to create a system 1000 will cause the rotational stability of the system 1000 to be disrupted at certain positions in the rotation, but this rotational instability can be reduced by increasing the number of system 100s used to make up a system 1000. This rotational instability does not change, with respect to the concepts described above, the basic manner in which the system 1000 functions.

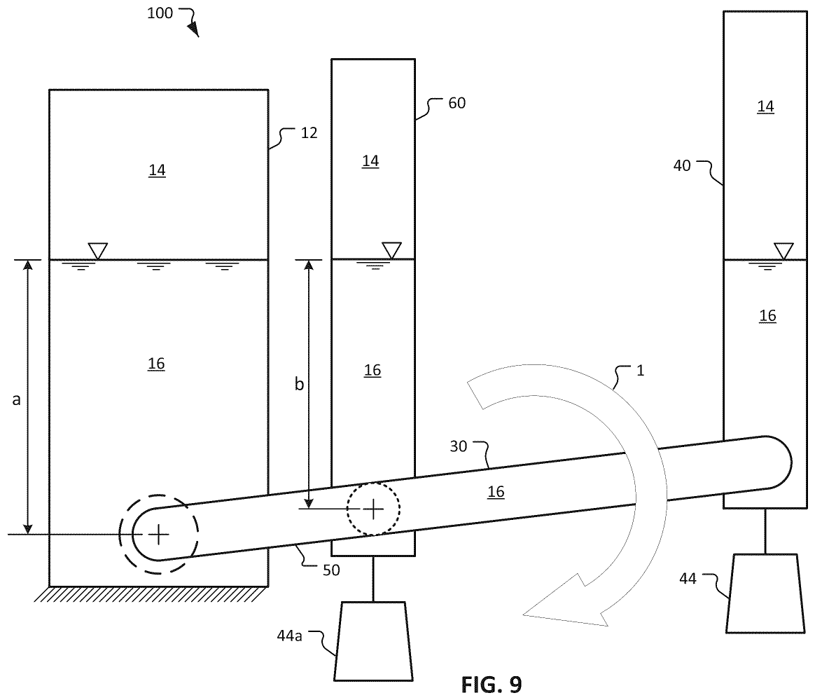

Turning our attention to FIG. 9, as the outer container 40 and middle container 60 rotate around the fixed container 12, the volume of the water 16 in each of the three containers 12, 40, and 60 changes. Generally, as the middle container 60 and the outer container 40 rotate 180° between the 12 o'clock and 6 o'clock positions, water 16 drains from the fixed container 12 and flows into the middle container 60 and the outer container 40. This process is reversed as the middle container 60 and the outer container 40 rotate 180° from the 6 o'clock to the 12 o'clock positions.

If the fixed container 12, the middle container 60, and the outer container 40 are spaced apart on the short lever conduit 50 and the interconnecting lever conduit 30 correctly, and if the fixed container 12, the middle container 60 and the outer container 40 are sized properly, then, in a complete 360° rotation of the middle container 60 around the fixed container 12, the height of the column of the water 16 in the fixed container 12 will decrease at the same rate that the height of the column of water 16 in the middle container 60 will increase on one side of the rotation (from 12 o'clock to 6 o'clock), and the height of the column of water 16 in the fixed container 12 will increase at the same rate as the column of water 16 in the middle container 60 will decrease on the other side of the rotation (from 6 o'clock to 12 o'clock). Or said another way, if the fixed container 12, middle container 60 and outer container 40 are sized and positioned properly, the fixed container's 12 column of water 16 will fall at the same rate that the middle container's 60 column of water 16 rises on one side of the rotation, and the fixed container's 12 column of water 16 will rise at the same rate that the middle container's 60 column of water 16 falls on the other side of the rotation.

In FIG. 9, the distance “a” is the total distance between the upper surface of the water 16 in the fixed container 12 and the central axis about which the interconnecting lever conduit 30 and short interconnecting lever conduit 50 rotate (i.e., the central axis of the tube 20). The distance “b” is the total distance between the upper surface of the water 16 in the middle container 60 and the central axis of the rotary union 32a (FIG. 7) that connects the short lever conduit 50 to the middle container 60. At all rotational positions of the interconnecting lever conduits 30 and 50 (and the containers 40 and 60) relative to the fixed container 12, the sum total of the distances “a”and “b”is always a constant distance.

The reason for this is that as the middle container 60 and outer container 40 fall in their rotation from the 12 o'clock position to the 6 o'clock position, both containers take in a volume of water 16 from the fixed container 12, and as the middle container 60 and the outer container 40 rise in their rotation from the 6 o'clock position to the 12 o'clock position, both containers 40 and 60 give back a volume of their water 16 to the fixed container 12.

The volumes of water 16 that move between each of the three containers, 12, 40 and 60 are dependent on two relationships. The first relationship is the relative position (elevation) of each container relative to the other two containers, at each position in the rotation. The second relationship is the cross-sectional areas of the fluid surface in each container in relation to the other two containers. The distance from the pivot point found on fixed container 12 that the middle container 60 and the outer container 40 are located at, determine how far, and at what speed, each container falls and rises in a complete rotation.

As shown in FIG. 10, the system 100 also includes a float 210, a holding tank 220, and a tether 250. The float 210 is a buoyant member in the fixed container 12. The holding tank 220 is an open-bottom buoyant member in the middle container 60. The presence of the float 210 and the holding tank 220 does not change, with respect to the concepts described above, the basic manner in which the system 100 functions.

The tether 250 attaches the float 210 and the holding tank 220 to each other. Accordingly, the movements of the float 210 and the holding tank 220 are linked together by the tether 250, which has a constant length. The tether 250 is routed between the fixed container 12 and the middle container 60 in a manner that allows for the rotation of the tube 20 without affecting (e.g., entangling) the tether 250. For example, in some embodiments the tether 250 is routed through an outer sleeve surrounding the tube 20.

The float 210 and the tether 250 are designed to keep holding tank 220 from rising in relation to the upper surface of the water 16 (the waterline) found in middle container 60. If holding tank 220 does rise from changes in its buoyancy, the lost displacement of the fluid 16 is replaced by the greater displacement of fluid 16 from the float 210. The purpose of strategically sizing each container 12, 40 and 60 and placing middle container 60 and outer container 40, a certain distance from the pivot point found on fixed container 12, all as described above, is so that tether 250 does not lose its effectiveness because of the changing water levels in fixed container 12 and middle container 60.

Since the float 210 and the holding tank 220 are residing at the interface between the water 16 and the air 14 in each of the fixed container 12 and the middle container 60, respectively, it can be envisioned that as water 16 flows into or out of the holding tank 220, as described below, the corresponding change in volume of the water 16 (and mass of the water 16) will be substantially greater in outer container 40 than if the float 210 and the holding tank 220 were not present in the fixed container 12 and the middle container 60.

The holding tank 220 is a container with an at least partially open bottom portion (so that water 16 can pass into and out of the interior of the holding tank 220). At least an upper portion of the interior of the holding tank 220 contains air 14, which keeps it buoyant. Inside of the holding tank 220 is a fluid-to-air interface line 19 between the denser water 16 and the less dense air 14. Changes in the volume of air 14 found in the holding tank 220 inversely change the amount of water 16 in the holding tank 220. That is, as air 14 is added into the interior of the holding tank 220, the fluid-to-air interface line 19 lowers within the holding tank 220 and some water 16 from the interior of the holding tank 220 exits the holding tank 220 and enters the middle container 60 (on the outside of the holding tank 220).

Since all three containers 12, 40, and 60 are in fluid communication with each other, as the water 16 exits the holding tank 220 and enters the middle container 60 (outside of the holding tank 220), the elevation of the water 16 in each of the containers 12, 40, and 60 rises (to stay at equal elevations). Because the surface areas of the water 16 in the fixed container 12 and the middle container 40 are much smaller (due to the crowding-out effect of float 210 and the holding tank 220) than the surface area of the water 16 in the outer container 40, an equal rise in elevation corresponds to a receipt in the outer container 40 of a much greater volume of the water 16. That is, when air is added to the holding tank 220, the outer container 40 receives a much greater volume and weight of water 16 than the fixed container 12 or the middle container 60, than outer container 40 would have received without the presence of float 210 and holding tank 220.

Again, as air is added to the holding tank 220 the resulting rise in the elevations of the water 16 in each of the containers 12, 40, and 60 will be equal. That holds true no matter how long the interconnecting lever conduit 30 is. That is the nature of a communicating fluid vessel system. For example, the rise in the elevations of the water 16 in each of the containers 12, 40, and 60 will be equal when the interconnecting lever conduit 30 is short, and the rise in the elevations of the water 16 in each of the containers 12, 40, and 60 will be equal when the interconnecting lever conduit 30 is long. Said differently, the fact that the elevations of the water 16 in each of the containers 12, 40, and 60 are equal is independent of the length of the interconnecting lever conduit 30.

As described above in reference to FIGS. 6 and 7, when the system 100 is oriented between the 12 o'clock position and the 6 o'clock position, clockwise torque will be generated at the sprocket 22. Of course, since torque equals force times distance, more torque will be generated when the interconnecting lever conduit 30 is longer than when the interconnecting lever conduit 30 is shorter. This essentially is the mechanical advantage of a lever (i.e., the interconnecting lever conduit 30). Accordingly, while the rise in the elevations of the water 16 in each of the containers 12, 40, and 60 is independent of the length of the interconnecting lever conduit 30, making the interconnecting lever conduit 30 longer generates more clockwise torque at the sprocket 22 (when the system 100 is oriented between the 12 o'clock position and the 6 o'clock position) than a shorter interconnecting lever conduit 30.

The float 210 (in the fixed container 12) and the holding tank 220 (in the middle container 60) are tethered to each other so that together they displace a constant volume of their surrounding water 16 as they float in the fixed container 12 and the middle container 60. The float 210 and the holding tank 220 are tethered to each other so that the total displacement of both the float 210 and holding tank 220 remains the same, even as the elevations of the columns of water 16 change in the three containers 12, 60, and 40 (e.g., as the middle container 60 and outer container 40 rotate around the fixed container 12, refer to FIG. 6). In addition, the float 210 and the holding tank 220 are designed to minimize the surface area of the water 16 in the fixed container 12 and middle container 60 so that any changes to the elevations of the columns of the water 16 (not caused by the rotation of outer container 40 and middle container 60) will be allocated on a volume and weight basis to a greater extent to the outer container 40 than to the fixed container 12 or the middle container 60. Said another way, changes to the displacement of water 16 by holding tank 220 because of changes in the volume of air 14 in holding tank 220 are volumetrically allocated in favor of outer container 40.

It is advantageous when changes in the holding tank's 220 displacement of its surrounding water 16 cause the greatest changes in the volume and weight of water 16 in the outer container 40. That is the case because the outer container 40 is the container located farthest from the pivot point (at the axis of the tube 20), will maximize the mechanical advantage of the interconnecting lever conduit 30. In other words, the torque at the sprocket 22 (FIGS. 6 and 7) that is generated by the outer container 40 between the 12 o'clock and 6 o'clock positions is increased to a greater extent when the majority of the weight of the water 16 is added to the outer container 40 (rather than to the fixed container 12 or the middle container 60).

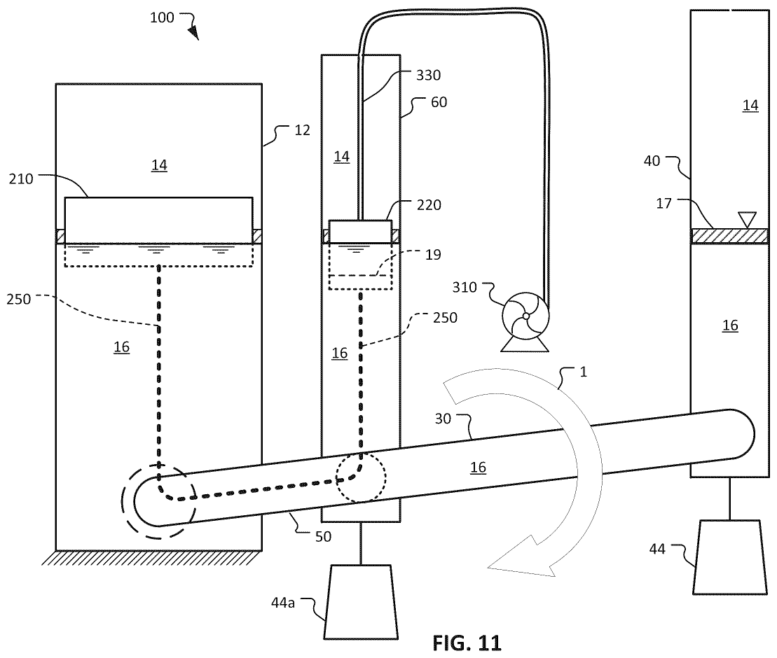

As shown in FIG. 11, the system 100 also includes a compressor 310. The compressor 310 can discharge a pressurized gas, such as air 14, to infill the holding tank 220. The compressor 310 can be electrically driven by a motor in some embodiments. In some examples, the compressor 310 can be mechanically assisted by the rotations of the interconnecting lever conduit 30 and/or the short lever conduit 50.

As air 14 is moved into holding tank 220, gravity causes the elevation of the water 16 in middle container 60 to seek equilibrium, moving a volume of the water 16 to the fixed container 12 and a volume of the water 16 to outer container 40. Said another way, the water column heights of the vessels within the system 100 will always seek elevation equilibrium. The allocation of the change in volume and weight of the water 16 displaced by the change of the volume of the air 14 in the holding tank 220 is divided between the fixed container 12, the outer container 40, and middle container 60 based upon the surface areas of the water 16 in each of the three containers 12, 40, and 60. Since the float 210 and holding tank 220 are designed to crowd out most of the surface area of the water 16 in the fixed container 12 and the middle container 60, most of the change in the volume and weight of the water 16 occurs in the outer container 40. This principle holds true as the amount of air 14 in the holding tank 220 increases (a greater amount of increase of volume/weight of the water 16 occurs in the outer container 40 as compared to if the float 210 and holding tank 220 were not present), and also as the amount air 14 in the holding tank 220 decreases (a greater amount of decrease of volume/weight of the water 16 occurs in the outer container 40 as compared to if the float 210 and holding tank 220 were not present).

Air 14 is moved to and from holding tank 220 by way of the compressor 310. The air 14 is moved into holding tank 220 when its outer container 40 is at the top of the rotation (at the 12 o'clock position), and the air 14 is moved out of the holding tank 220 when its outer container 40 is at the bottom of the rotation (at the 6 o'clock position). Operating the compressor 310 in this manner is akin to expanding the bladder 3 of the system 10 in FIGS. 1-4 to displace the additional fluid 17 to the top of the fluid column in the outer container 40.

It should be understood that the additional fluid 17 found in the outer containers 40 on one side of the rotation (from 12 o'clock to 6 o'clock), but not the other side of the rotation (from 6 o'clock to 12 o'clock), is used to rotate the system 1000. After the additional fluid 17 in each outer container 40 reaches the bottom of the rotation (at 6 o'clock), the additional fluid 17 is then shifted out of its outer container 40 and melds into the fluid 16 of the overall system 100. Since the fluid 16 is fungible, the force of the additional fluid 17, as it melds into the fluid 16 of its overall system 100, essentially moves from outer container 40 back to middle container 60 and fixed container 12, and remains in middle container 60 and fixed container 12, until it is again needed when its outer container 40 is at the top of the rotation (at 12 o'clock).

Essentially, the additional fluid 17 in each outer container 40 falls from the top of the rotation (at 12 o'clock) to the bottom of the rotation (at 6 o'clock), causing the system 1000 to rotate. At the bottom of the rotation (at 6 o'clock), the additional fluid 17 is moved away from its outer container 40 and becomes part of the fluid 16 in its overall system 100. This transfers the volume/weight of additional fluid 17 to the middle container 60 and fixed container 12, to wait until the outer container 40 once again reaches the top of the rotation (at 12 o'clock).

In its simplest form the system 100 is the combination of: (i) a lever and (ii) a communicating fluid vessel system. To work in cooperation with substantial effectiveness, a number of these lever/communicating fluid vessel systems 100 can be coupled or ganged together in a rotationally balanced fashion to create the overall system 1000 (e.g., as shown in FIG. 6) with the interconnecting lever conduits 30 being equally spaced apart like spokes in a Ferris wheel. The pivot points of the interconnecting lever conduits 30 of the overall system 1000 represent the center of this Ferris wheel-like design, and the gondolas at the end of each spoke correspond to the outer containers 40. If each system 100 had a common pivot point, the outer containers 40 would become entangled with each other. Therefore, the overall system 1000 can be designed so that each system 100 is coupled to a common shaft, and the common shaft can also drive an electricity generator, pump, or other useful device.

The overall system 1000 (e.g., as shown in FIG. 6) is designed so that the added weight from the additional fluid 17 in the outer container 40 at the end of each interconnecting lever conduit 30 (resulting from changes in the column heights in its communicating vessels) intentionally occurs on one side of the rotation of the outer containers 40, and does not occur on the opposite side of the rotation. By ganging these systems 100 together, and by adding work to the systems 100 from the compressors 310, rotational energy is applied to the common shaft to make the system 1000 rotate.

Some of the rotational energy created by the rotating system 1000 is consumed by the energy required to lift the fluid 16 in each outer container 40 from the bottom of the rotation back to the top of the rotation. However, decreasing the volume of air 14 in holding tank 220 when its outer container 40 is at the bottom of the rotation decreases the amount of fluid 16 in outer container 40. Additionally, before air 14 is moved into the holding tanks 220 of any of the multiple systems 100 that are ganged together, the wheel and axle design is rotationally balanced. Being rotationally balanced reduces the work needed to rotate the wheel to return each outer container 40 from the bottom to the top of the rotation.

As described above, moving air 14 into the holding tank 220 increases the elevation of the fluid 16 in the middle container 60. Then, after the fluid elevations in all three containers 12/40/60 have naturally equalized, the fluid Vadditional 17 results at the end of the interconnecting lever conduit 30. Conversely, moving air 14 out of the holding tank 220 reduces the elevation of the fluid 16 in the middle container 60. Then, after the fluid elevations in all three containers 12/40/60 have naturally equalized, Vadditional 17 is no longer present at the end of its lever conduit 30.

Increasing the length of the interconnecting lever conduit 30 in each system 100 increases the distance that each Vadditional 17 can fall during rotation, which increases the work that each Vadditional 17 can individually do.

The holding tank 220, being linked to the float 210 by the tether 250, maintains its partially submerged orientation with respect to the interface between the fluid 16 and the air 14, as the elevation of the fluid 16 in middle container 60 rises and falls. This position maintains the effectiveness of the displacement of fluid 16 in holding tank 220 (to be in favor of the outer container 40 by weight/volume of water 16), as well as reduces the amount of work needed from the compressor 310 to move air 14 into and out of holding tank 220.

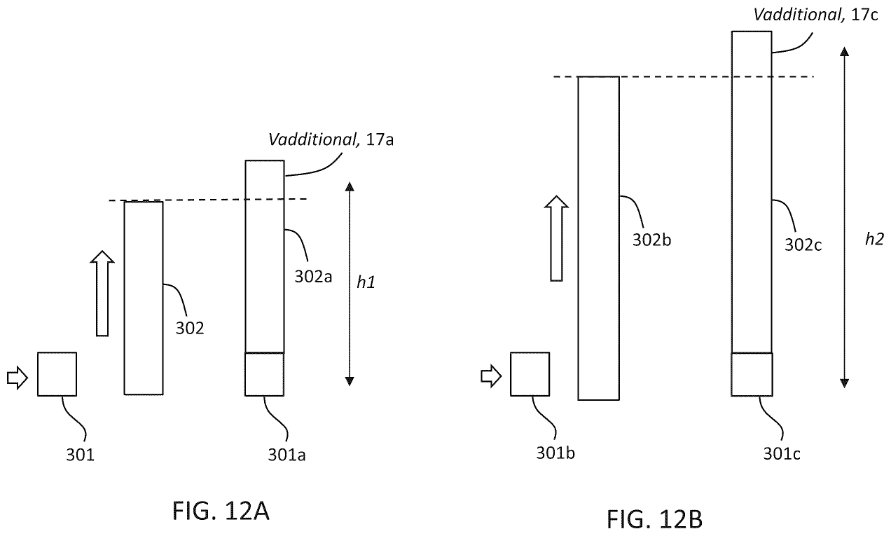

FIGS. 1-11 describe the system 100 embodied as a continuous rotational system where the outer container 40 rotates or revolves 360° around the fixed container 12, but it is possible to harness the benefits of the system as a limited rotational system where an outer container does not fully rotate or revolve around a fixed container. To this end, FIGS. 12-21 describe a system having at least one communicating vessel with at least one lever, which are constructed as a rotationally balanced structure. The system uses changes in fluid pressure to shift fluid mass to a fluid column of a communicating vessel located at the end of the lever when the lever is at the top of its rotation, such as at the 1 o'clock position, and uses changes in fluid pressure to shift fluid mass away from a fluid column of a communicating vessel at the end of the lever when the lever reaches the bottom of its rotation, such as at the 5 o'clock position.

The systems and methods of the present disclosure are designed to exploit a corollary of the physical laws governing offsetting fluid pressures inherent in fluid held in a communicating vessel. This corollary, which may be referred to herein as the fluid seesaw effect, allows a fixed amount of work applied to change the fluid pressure in one fluid column of a communication vessel, that is Work Input, to change a fixed volume of the fluid mass at the top of the other fluid column, independent of the starting fluid column heights, and independent of the length and angle of the connecting hose. The fluid seesaw effect is further based on assumptions in structure, including that there are the same surface areas of the taller and shorter starting fluid column heights in the containers. And that the same amount of Work Input is applied to the taller and shorter starting fluid column heights represented by displacing the same volume at the same depth of the fluid in both examples.

The offsetting fluid pressure forces inherent in a communicating vessel act much like the offsetting forces of a balanced seesaw, where balanced forces acting on ends of an elongated member, supported with a single pivot point near the midpoint, act to maintain the elongated member in balance about the pivot point. However, there is at least one key difference. As one side of a balanced seesaw falls, giving up a portion of its potential energy to lift the other side, which gains potential energy (i.e. an Energy Transfer within the seesaw system), the amount of mass on both sides of the seesaw remains the same. In the present disclosure, however, as a higher-pressure fluid column in a communicating vessel, seeking equilibrium with its lower-fluid pressure counterpart, gives up a portion of its potential energy to lift and fill in underneath a lower pressure fluid column, which gains potential energy (i.e. an Energy Transfer), the volume of fluid mass in the lower pressure fluid column increases. Importantly, when the additional fluid mass is shifted into the bottom of the lower-pressure fluid column, it appears, when compared to the original lower-pressure fluid column, that the additional fluid mass was lifted to the top of the lower-pressure fluid column.

Said another way, shifting additional fluid mass into the bottom of the lower-pressure fluid column makes available the stored energy of an equal amount of fluid mass at the top of the lower-pressure fluid column. This is possible because the additional fluid mass shifted into the bottom of the lower-pressure fluid column displaced, e.g., pushed out or lifted up, the fluid mass that existed at that position before it was replaced by the new, and additional, fluid mass. This process of displacement continues, with fluid being pushed up and replacing the fluid mass that was there, such as is described in the fluid chain example previously discussed, until at the top of the lower-pressure fluid column, Vadditional is created where there was not any fluid mass before. It appears that Vadditional is actually the only additional fluid mass that was added to the original lower-pressure fluid column.

The reason that shifting new fluid mass into the bottom of a lower-pressure fluid column makes available the potential energy of Vadditional is because, when compared to the lower-pressure fluid column, Vadditional is the only “new”fluid mass in the container that holds it. Most importantly, Vadditional is at a higher height than the actual additional fluid mass added at the bottom of the lower-pressure fluid column.

To provide further explanation of this point, referring back to FIG. 1, as ball 2 is squeezed moving air into bladder 3, the fluid pressure in the bottom of the fluid column found in container 12 increases, which seeks equilibrium with the fluid column found in container 40. The higher-pressure fluid found in container 12 pushes into the fluid found in interconnecting lever conduit 30, which in turn pushes an equal volume of fluid into the bottom of the fluid column found in container 40, which creates “new” fluid mass at the top of the fluid column found in container 40, which we call Vadditional 17. As previously discussed, a simple visual representation of this process is akin to the links in a chain, or conceptually a fluid chain, where each fluid link moves toward container 40, a short distance, thereby creating a shortage of a fluid link or links in container 12 and an additional fluid link or links at the end of the fluid chain found at the top of the fluid column in container 40, which is called Vadditional 17. This gain in height, between the additional fluid mass shifted to the bottom of a fluid column in a communicating vessel, and the height that Vadditional 17 is created, is referred to herein as the fluid chain shift.

This fluid chain shift in the communication vessel system 10, in conjunction with the offsetting fluid pressures inherent in the fluid found in a communicating vessel, makes the fluid seesaw effect possible. That is, the addition of a fixed amount of work applied to fill bladder 3 with air, Work Input, will create a consistent volume of Vadditional 17 at the top of the fluid column found in container 40, independent of the starting fluid column heights of the fluid columns in 12, 40, and independent of the length and angle of the interconnecting lever conduit 30. And the opposite is true, that is the addition of a fixed amount of work applied to drain the bladder 3 of air, Work Input, can eliminate Vadditional 17 at the top of the fluid column found in container 40, independent of the starting fluid column heights of the fluid columns in 12, 40, and independent of the length and angle of the interconnecting lever conduit 30.

In the creation of Vadditional 17, because of the fluid seesaw effect, the greater the starting fluid column heights of the fluid column in container 12, 40, and the closer that bladder 3 is positioned to the surface, the greater the Energy Transfer within the system as compared to the amount of Work Input to fill the bladder 3. See, for example, FIGS. 2-3 which illustrate the difference relative to two different heights, h₁ and h₂. The gain in height in the creation of Vadditional 17, by increasing the starting fluid column heights, was largely created by an Energy Transfer within the system and not Work Input.

To provide further clarity in disclosure, reference is made to FIGS. 12A and 12B, which are representative diagrammatical illustrations of the relationship between Work Input, Energy Transfers and the fluid chain shift in gaining height in the creation of Vadditional, in accordance with the present disclosure As shown, square 301 represents the additional fluid mass which will shift into the bottom of a lower-pressure fluid column in a communicating vessel. The vertical rectangle 302 represents a fluid column in a communicating vessel. As the pressure is increased in an adjacent fluid column of the communication vessel, the now lower-pressure fluid column 302a is lifted and the additional fluid mass 301a is pushed underneath fluid column 302a creating, due to the fluid chain shift, Vadditional 17a at the top of fluid column 302a. The difference in height between actual new additional fluid mass 301a added at the bottom of fluid column 302a and the height (h₁) that Vadditional 17a is created was made possible by the fluid chain shift.

In this example, it is helpful to think that the work needed to lift fluid column 302 was contributed from an Energy Transfer within the system (muck like the balanced seesaw example), the work needed to shift the additional fluid mass 301a underneath fluid column 302a as contributed by Work Input and for the creation of Vadditional 17a at h₁ to be caused by the fluid chain shift.

By comparison, FIG. 12B illustrates the same concept, where square 301b represents the additional fluid mass which will shifted into the bottom of a lower-pressure fluid column 302b in a communicating vessel. The vertical rectangle represents a fluid column 302b in the communicating vessel. As the pressure is increased in an adjacent fluid column of the communication vessel, the now lower-pressure fluid column 302c is lifted and the additional fluid mass 301c is pushed underneath fluid column 302c creating, due to the fluid chain shift, Vadditional 17c at the top of fluid column 302c. By understanding the fluid chain shift as applied to two different heights, it is possible to understand how Vadditional 17c can be created at a higher height (h₂) by starting with a taller fluid column 302c, and most importantly, with most of the work contributed to lifting a taller starting fluid column 302b by an Energy Transfer within the system, and not by additional work contributed by Work Input. The inventive systems and methods of this disclosure use this gain in height in the creation of Vadditional 17 from work contributed by an Energy Transfer within the system and Input Work, to run.

This interplay between Work Input and the resulting Energy Transfer within the communicating vessel system, and the fluid chain shift, is at least part of what makes possible the fluid seesaw effect, where a fixed amount of work applied to change the fluid pressure in one fluid column of a communication vessel, will create a fixed volume change of fluid mass at the top of the other fluid column, independent of the starting fluid column heights, and independent of the length and angle of the connecting hose.

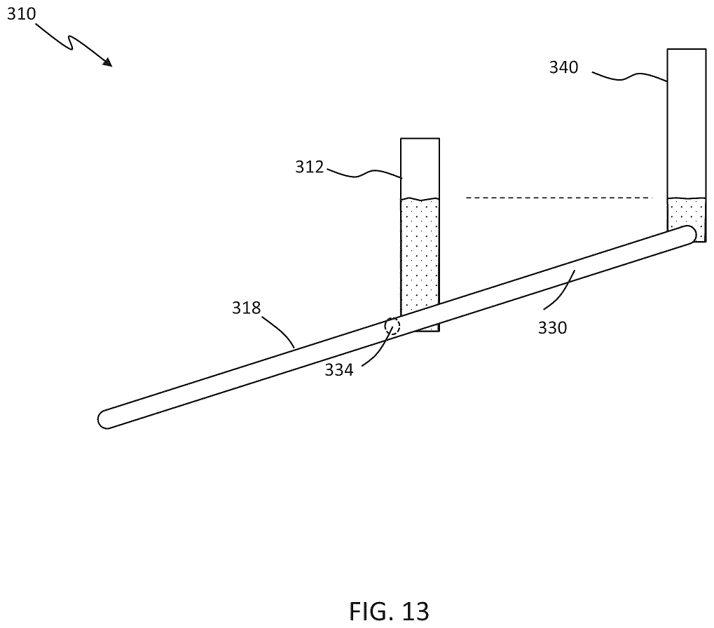

In further detail, FIG. 13 is a schematic front view illustration of a fluid communicating vessel 310, in accordance with the present disclosure. With reference to FIG. 13, the communicating vessel 310, which may be referred to herein as “communicating vessel system 310” or “system 310,” is constructed with interconnecting conduit 330 which contains the fluid and is rotatably coupled to at least containers 312, 340. The interconnecting conduit 330 also defines a fluid passageway by which the containers 312, 340 (and additional possible containers) are in fluid communication. Accordingly, the interconnecting conduit 330 is both mechanically connected between containers 312 and 340 and is in fluid communication with containers 312 and 340, such that containers 312, 340 are physically and fluidically connected to the interconnecting conduit 330 such that fluid can move between containers 312 and 340 by the interconnecting conduit 330. The fluid pathway within the interconnecting conduit 330 may include an internal passageway which allows for the flow of fluid, or it may include a connecting hose or similar structure which allows fluid to move between containers 312, 340. Interconnecting conduit 330, containers 312, 340 and the fluid contained therein, are the primary components of communicating vessel 310.

The interconnecting conduit 330 of the communicating vessel 310 is integrated into, or attached, to lever 318 which is pivotal about an axis 334. Container 312 sits on, near or to the side of the axis 334 of lever 318 and container 340 sits at or near the end of lever 318. Interconnecting conduit 330, which runs along or is integrated into lever 318, fluidly connects container 312 to container 340.

In operation, as lever 318, with interconnecting conduit 330, rotates upward and downward, the containers 312, 340 maintain an upright orientation by way of weights connected to the bottom of containers 312, 340 (not shown) or a cross bar at or near the top of the fluid containers 312, 340 (not shown), or such other configuration which may be convenient to keep fluid container 312, 340 in an upright position while lever 318, with its interconnecting conduit 330, rotates.

System 310 is rotationally balanced about axis 334, such that the fluid found in containers 312, 340 and interconnecting conduit 330, and any other parts or components that are part of the system 310, are positioned on, or outside of, the lever 318 exert forces on the axis 334 that result in the net rotational force, or net torque, being equal to zero. That is, the rotational balance of the system 310 remains at every degree in the system 310 rotation, both upward and downward, despite changes in the fluid column heights in containers 312, 340 which rise and fall as the lever 318 rotates.

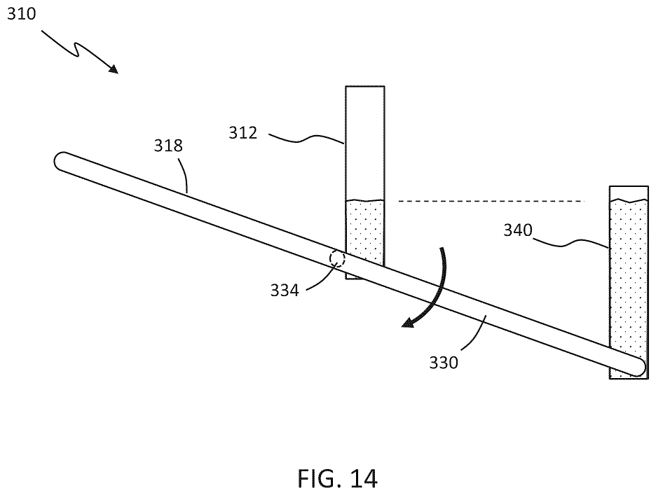

With the system 310 having a rotational balance, and with the containers 312, 340 being fluidly connected by way of interconnecting conduit 330, changes in the fluid column pressure of container 312 will cause changes in the amount of fluid mass in container 340. When the change in pressure of container 312 causes an increase in fluid mass in container 340, e.g., by a quantity of fluid successively shifting away from container 312, into the interconnecting conduit 330, which shift an equal volume of fluid into container 340, this additional fluid mass will cause an additional downward force at the end of the lever 318 due to the gravitational force acting on an increased mass. For instance, starting at a first position as shown in FIG. 13, with the end of the lever 318 on which container 340 is located being positioned approximately at the 2 o'clock position, an increase to the fluid column pressure of container 312 will cause fluid to move from the bottom of container 312, into the interconnecting conduit 330, which results into a volume of fluid shifting into the bottom of container 340. This additional fluid mass within container 340 will change the balance of the system 310, such that the end of the lever 318 with container 340 will exert an additional downward force at this end of the lever 318. In turn, this causes rotation about the axis 334. The lever 318 may continue on a rotational path until it reaches a bottom position, for instance, a position as shown in FIG. 14. Thus, increases of the fluid pressure of container 312 increases the fluid mass in container 340 to thereby rotate the lever 318 of system 310 downward when the lever 318 is at or near the top of its rotation. This increased mass of the fluid in container 340 increases a torque about axis 334 of system 310.

Similarly, decreasing the fluid pressure in container 312 will decrease the fluid mass in container 340, thereby reducing the downward force at this end of lever 318, when the lever 318 is at or near the bottom of its rotation. This decreased mass of the fluid in container 340, decreases a torque exerted on the axis 334 of system 310. Since the system 310 is rotationally balanced, these increases or decreases in the fluid pressure of container 312 correspond to increases and decreases of additional fluid mass (beyond the fluid mass that exists in container 340 in the system 310's rotationally balanced state at each point of rotation) draining into or from container 340, which increases or decreases the torque exerted on the axis 334 of lever 318 of system 310.

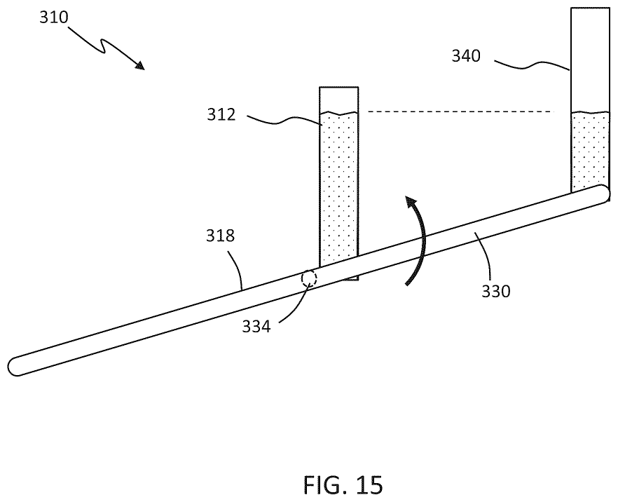

For example, when starting at the bottom position, as shown in FIG. 14, decreasing the fluid pressure in container 312 will cause a volume of the fluid mass from container 340 to move into the interconnecting conduit 330, which results in an equal volume of fluid moving from interconnecting conduit 330 into container 312, thereby reducing the downward force at the end of the lever 318 where container 340 resides. This reduced downward force at the end of the lever 318 where container 340 resides returns the system 310 to a rotationally balanced state, where it will remain absent additional forces exerted on it. To raise the end of the lever 318 at which container 340 is positioned, an additional unbalancing force may be applied. For example, a counterweight, other fluid columns, or an additional decrease of pressure or fluid mass can be used to upset the balance of system 310, thereby further decreasing the downwards force at the end of the lever 318 where container 340 is located, which can initiate upwards rotation at this location, as shown in FIG. 15, for example. The process of moving the lever 318 of system 310 in a rotational manner about axis 334 may continue through one or more cycles or partial cycles, such as between fully raised and fully lowered positions of the container 340, or along a partial rotational path thereof.

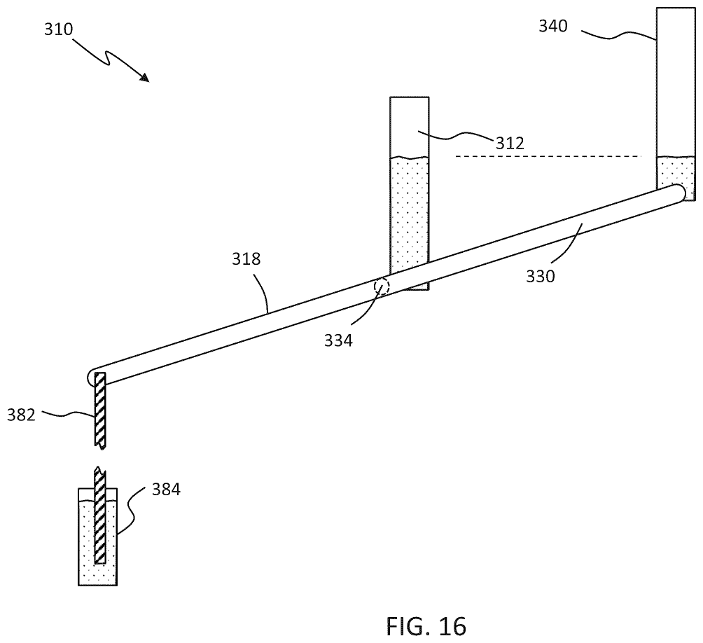

There are a number of design variations of the system 310 to allow it to be rotationally balanced. FIG. 16 is an example of one variation, where a fluid container 384 is added in a position below lever 318 on the opposite side of the axis 334 from fluid container 340. Fluid container 384 is filled with a fluid, which may have the same density as the fluids in containers 312, 340 and interconnecting conduit 330. A fluid rod 382 may be attached to the terminating end of the lever 318 positioned on the opposite side of fluid container 340. The fluid rod 382 may be a weighted rod, and the fluid container 384 may be filled with a fluid which has substantially the same density as the fluid rod 382. The fluid rod 382 may be attached to the terminating end of the lever 318 by a pivot, or other mechanism which enables the fluid rod 382 to maintain an upright orientation. This maintained upright orientation of the fluid rod 382 allows the fluid rod 382 to move into and out of the fluid in container 384. Since the fluid in container 384 and the fluid rod 382 may be the same density, as the fluid rod 382 moves into and out of the fluid, it applies a downward force on the terminating end of the lever 318 only from the portion of the fluid rod 382 that is above the surface of the fluid in container 384. In some examples, the density of the fluid rod 382 and the density of the fluid can be different. In other examples, the fluid rod 382 and container 384 may be located at different positions along the lever 318. For example, container 384 and the fluid rod 382 may be positioned halfway between the axis 334 and the terminating end of the lever 318 opposite from container 340. In such an arrangement, the height of container 384 and fluid rod 382 may be decreased. Depending on the densities, sizes and position of fluid rod 382 and the fluid in container 384, other forms of weights may be added to create a rotationally balanced system 310.

The system 310 may utilize one or more devices, systems, or mechanisms to change, and maintain, the fluid pressure of the fluid in the communicating vessel 310 at certain positions in the rotation.

As previously discussed, the system 310 utilizes the offsetting fluid pressures inherent in a communicating vessel to shift fluid mass between two or more fluid columns in the system 310. In a two fluid column communicating vessel, such as communicating vessel 310 of FIGS. 13-14, the dividing line between the offsetting fluid column pressures of the communicating vessel is the deepest point in the fluid. Therefore, with communication vessel 310, as an example, depending on the angle of the interconnecting conduit 330 between the fluid columns 312, 340, the fluid in the interconnecting conduit 330 may be part of the fluid column found in container 312 or may be part of the fluid column found in container 340. If interconnecting conduit 330 is horizontal, it can be assumed that the midway point between the two fluid columns in container 312 and 340 is the dividing line.

If the interconnecting conduit 330 points upward from container 312 to container 340, then the dividing line between the offsetting fluid column pressures is at the bottom of the fluid column in 312. But if the interconnecting conduit 330 points downward from container 312 to container 340, then the dividing line between the offsetting fluid column pressure is at the bottom of the fluid column in container 340. This is because for fluid at rest, the pressure at a specific depth is determined by the weight of the fluid above it. Because the fluid in the system 310 keeps moving toward a lower fluid pressure region until the pressure at any two horizontal points is equal, the greatest pressure at the bottom of the fluid columns.

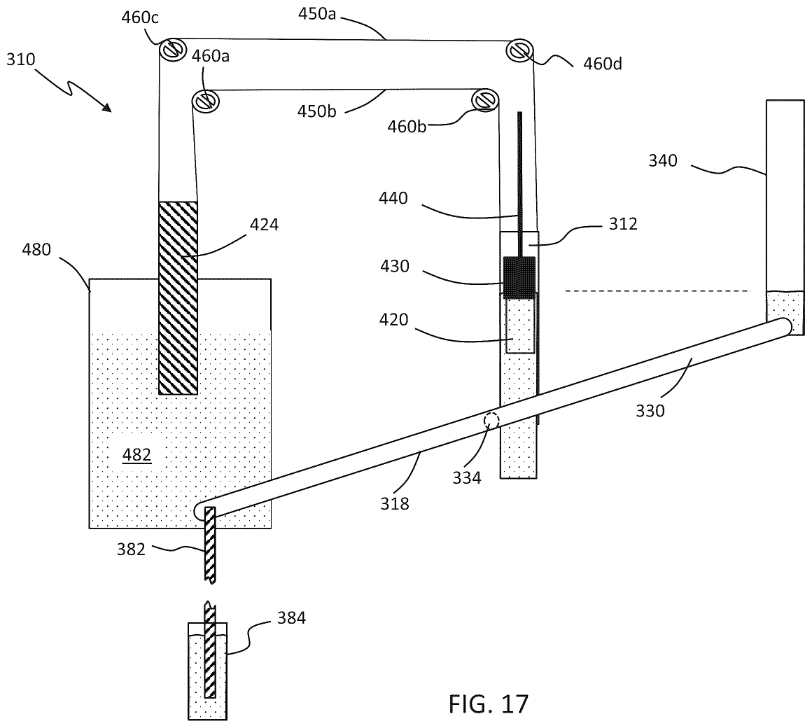

The systems and the methods described herein can be further described relative to FIG. 17, which is a schematic front view illustration of a fluid communicating vessel, in accordance with the present disclosure.

In previous embodiments, such as those described relative to FIGS. 10-11, the holding tank(s) were used to maintain a position near the surface of the fluid column in which the holding tank resided by use of tether connected to another buoyant object found in an adjacent fluid column. The offsetting buoyancy of the buoyant objects was used to maintain the holding tank's position relative to the surface of the fluid column in which the holding tank resided. This configuration allowed the holding tank to rise and fall in lock step with the rise and fall of the fluid column in which the holding tank resided.

As the lever rotates and the fluid column heights in the communicating vessel increase and decrease, as fluid drains between fluid columns, it might be desirable to fix the holding tank's position in space and instead raise and lower the fluid column's container to keep the holding tank in position close to the surface of the fluid column in which the holding tank resides.

Referring to FIG. 17, container 312 and its fluid are located to the side of lever 318 at or near axis 334 but the fluid in container 312 remains in fluid communication with interconnecting conduit 330, and therefore container 340, since these components are in fluidic communication with one another. This may be achieved by, for example, a flexible hose (not shown) or similar fluid connection which permits movement of fluid to allows container 340 to rotate upward and downward and allows container 312 and its fluid to move upward and downward.

To raise and lower container 312, it is possible to use a weight 424 and an adjacent outer tank 480 which contains a fluid 482 not in fluid communication with the fluid in communicating vessel 310. Container 312 can be coupled to weight 424 by way of tethers and pulleys, preferably, two tethers 450a and 450b, and pulleys 460a, 460b, 460c and 460d. Other configurations and/or components may be possible and may be desirable, depending on the design and use of the system 310. For example, while not shown, a lever held at its axis 334 from above could be connected to container 312 and weight 424 may be used in lieu of tethers 450a and 450b and pulleys 460a, 460b, 460c and 460d.

As shown, container 312 is coupled to weight 424 by tether 450a and 450b. Tether 450a may be connected at the top to one side of container 312 and has a path the runs along or through pulleys 460c and 460d to attach to one side of weight 424. Tether 450b may be connected to the top of the other side of container 312, and tether 450b has a path the runs along or through pulleys 450a and 450b to attach to the other side of weight 424.

Weight 424 may be suspended partially above and partially below the surface of the fluid 482 in tank 480. In one example, the fluid 482 in tank 480 and the weight 424 may be of the same density such that only that portion of the weight 424 positioned above the surface of the fluid 482 in tank 480 applies a downward force on tethers 450a, 450b, which in turn creates an upward force on container 312, but it may be possible for the fluid 482 in tank 480 and the weight 242 to have different densities. In operation, as the fluid in container 312 drains, as the lever 318 and container 340 rotates downward (clockwise), the fluid found in container 312 decreases in volume thereby applying less downward force on tethers 450a, 450b which causes weight 424 to lift container 312 and its fluid to a higher elevation. And the opposite is true, that is as container 312 takes in fluid, as lever 318 and container 340 rotate upward (counter-clockwise), the fluid found in container 312 increases in volume thereby applying more downward force on tethers 450a, 450b, which causes an additional upward force on weight 424, lifting weight 424 out of the fluid 482 in tank 480. In this way, the lifting and falling of container 312, and its fluid, may maintain the holding tank in its proper position near the surface of the fluid found in container 312, as explained in further detail below. Other configurations are possible and may be desirable.

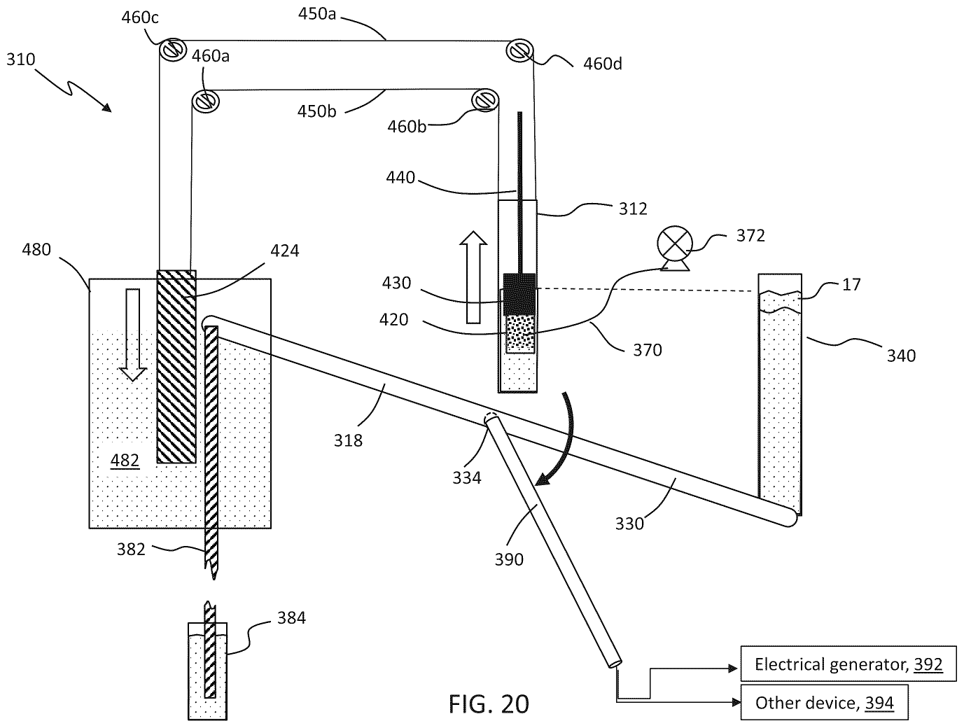

Additionally, a shaft 440 may be attached above and extend downward into container 312. At the bottom of shaft 440 is block 430 and holding tank 420. Block 430 may be formed from a material which is capable of maintaining a shape which can substantially conform to an inner shape of container 312, such that it can effectively occupy a significant portion of the surface area of the interior of container 312. Holding tank 420 may be coupled with block 430 and is positioned along the bottom edge or surface of block 430. Holding tank 420 may be open at the bottom, in a direction facing gravitationally downwards, and closed on all other sides and the top, such that the holding tank 420 has an inverted position. Holding tank 420 is connected to a supply of gas, such as air, with a hose and pump (FIG. 20), or with similar devices.

Block 430 and holding tank 420 are positioned in and/or above the fluid within container 312. Block 430 is sized large enough to generally crowd out most of the surface area of container 312 as the surface elevation rises when air is moved into holding tank 420.

A supply of gas, such as air, is in fluid communication with holding tank 420. In operation, supplying the gas to the holding tank 420 displaces a volume of fluid found in container 312, which in turn increases the fluid pressure at the bottom of the fluid column found in container 312. Increasing the fluid pressure at the bottom of the fluid column found is container 312 causes a volume of fluid to move into interconnecting conduit 330 which in turn causes and equal volume of fluid to move into the bottom of container 340 creating Vadditional 17 at the top of the fluid column found in container 340. And the opposite is true. Draining gas from holding tank 420 causes a volume of surrounding fluid in container 312 to move into holding tank 420. This decreases the fluid pressure at the bottom of the fluid column found in container 312, which causes a volume of fluid to move out of container 340 and into interconnecting conduit 330, which in turn causes an equal volume of fluid to move into container 312.

The holding tank 420 may receive a supply of gas, such as through a tube 370 connected to pump 372 (FIG. 20), whereby the supply of a gas is in fluid communication with the interior of the holding tank 420 in container 312. The pump 372 may be an air compressor, or similar device can be used to move gas into and out of holding tank 420.

As shown in FIG. 17, at the starting position in the operation of the system 310, holding tank 420 is submerged and has little or no air within the interior of holding tank 420, block 430 is mostly or entirely positioned above the surface of the fluid found in container 312, and weight 424 is mostly or entirely positioned out of the fluid in outer tank 480. Container 312 of communicating vessel 310 is full, or nearly full, of fluid and container 340 at the end of lever 318 is at the top of its rotation.

Air may then be added to holding tank 420 displacing a volume of fluid from the holding tank 420, which increases the fluid pressure at the bottom of the fluid column found in container 312. The increase of fluid pressure causes the fluid in the communicating vessel 310 to shift toward container 340, lifting up and filling in underneath the fluid column found in container 340, thereby creating Vadditional 17 (FIGS. 12A-12B) at the top of the fluid column found in container 340. This additional fluid mass shifted into container 340 upsets the rotational balance of system 310 causing the lever 318 and its container 340 to rotate downward.

As lever 318 and its container 340, rotate downward (clockwise) from the addition of a downward force created by Vadditional 17 (FIGS. 12A-12B), the fluid in container 312 drains into interconnecting conduit 330, causing an equal volume of fluid to drain into container 340. The draining of fluid from container 312 would normally reduce the surface elevation height of the fluid column found in container 312. If this happened, it would cause holding tank 420 to lose all or a portion of its displacement, since it is fixed in space. To maintain the position of holding tank 420 under the surface of the fluid found in container 312, as the fluid drains from container 312, weight 424 and container 312 and its fluid can cooperate and work together to lift container 312 at the same rate as the fluid column surface in container 312 falls from the draining of fluid out of container 312. And the opposite is true. That is, as lever 318 and its container 340, rotate upward (counter-clockwise), the fluid in container 340 drains into interconnecting conduit 330, causing an equal volume of fluid to drain into container 312. The draining of fluid from container 340 would normally increase the surface elevation height of the fluid column found in container 312, which, if happened, would cause holding tank 420 to move deeper into the fluid found in container 312. This would increase the necessary Work Input to move air into holding tank 420 when lever 318 reached the top of its rotation. However, to maintain the position of holding tank 420 under the surface of the fluid found in container 312, as the fluid drains from container 340, and thereby into container 312, weight 424 and container 312 and its fluid can cooperate and work together to cause container 312 to fall at the same rate as the fluid column surface in container 312 rises from the draining of fluid out of container 340 into interconnecting conduit 330. This causes an equal volume of fluid to drain from interconnecting conduit 330 to drain into container 312.

Since the system 310 substantially maintains rotational equilibrium at every degree in the rotation of the lever 318, the addition of an additional volume of fluid than would normally be found in container 340 at that position of rotation acts as an additional downwards force by way of the increased mass in container 340. The additional weight of the additional fluid mass found in container 340 also introduces a force which rotates the lever 318 downward. The presence of the additional volume of fluid in container 340 is maintained as the lever 318 rotates downward.

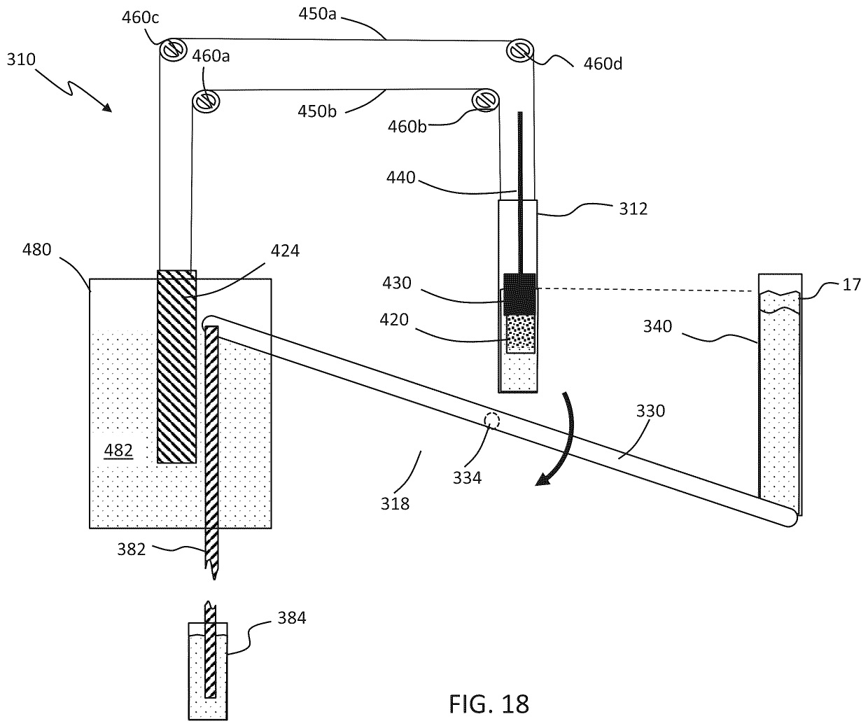

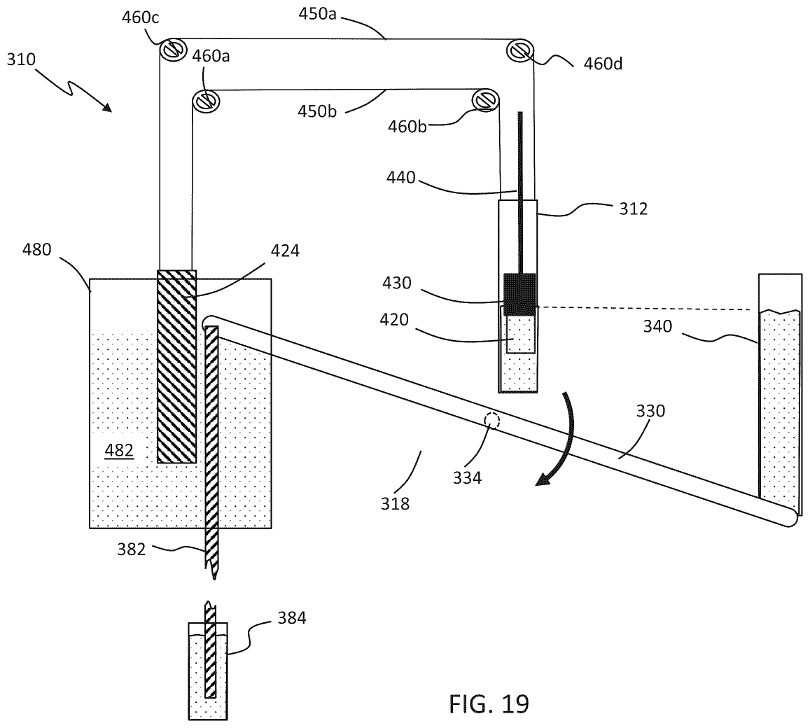

At the bottom of the rotation, as illustrated in FIG. 18, which is a schematic front view illustration of a fluid communicating vessel, in accordance with the present disclosure, the gas in the holding tank 420 is adjusted to cause the lowering of the fluid pressure at the bottom of container 312 which in turn causes the fluid pressure in the bottom of the fluid column in container 312 to be lower than the fluid pressure in the bottom of the fluid column of container 340. This causes the fluid in container 340 to shift toward container 312 by passing through the interconnecting conduit 330. In this way, the additional volume of fluid moved to container 340 reverts back into other portions of the system 310, to again make the system 310 rotationally balanced, as illustrated in FIG. 19.

Once the system 310 returns to a rotationally balanced state, as is illustrated in FIG. 19, the system 310 can be returned back to a starting position, such as the position illustrated in FIG. 17, with the use of a counterweight (not shown) which may be positioned at or proximal to a terminating end of the lever 318 opposite from container 340. The counterweight (not shown) may be sized and formed to weigh less than the weight of the additional volume of fluid shifted to container 340, but may be sufficiently weighted to overcome the friction of the overall system 310. In addition, the system 310, at the bottom of its rotation, may return to a state where the volume of fluid found in container 340 is less than the anticipated volume of fluid which would be found in container 340 in its rotationally balanced state, which is achieved by shifting a volume of fluid back toward container 312 that is greater than the volume of fluid that was shifted to container 340. This shifting would cause the system 310 to rotate upward until the lever 318 again reached the top of its rotation.

Accordingly, these principles are one technique for (i) changing the fluid pressure in one or more of the fluid columns of the communicating vessel, to shift fluid mass to the end of the lever when it is at, or near, the top of its rotation; a technique for (ii) holding steady the change in the fluid pressure in the communicating vessel as the lever rotates downward, and a technique for (iii) changing the fluid pressure in one or more of the fluid columns of the communicating vessel to shift fluid mass away from the end of the lever when the lever is at, or near, the bottom of its rotation.

It may be beneficial to maintain the holding tank 420 in a position near the surface of fluid found in container 312. Because Work Input is necessary to move air to and from holding tank 420, it may be ideal for the holding tank 420 to maintain a position as close to the surface of the fluid in container 312 as possible. Maintaining a position close to the surface of the fluid found in container 312 when air is moved into holding tank 420 may be desirable because it may take less added work, Work Input, to move a volume of air into the holding tank 420 held just under the surface, as opposed to a position where the holding tank 420 is closer to the bottom of the fluid found in container 312, because of the lower surrounding water pressure.

Using the fluid seesaw effect, the system 310 can be elongated and rebalanced to allow the additional fluid shifted to the end of the lever 318, when the lever 318 is at the top of its rotation, to fall from a higher elevation without increasing Work Input. Increasing the height that the additional fluid mass shifted to the end of the lever 318 can fall, can increase the Work Output of the system 310, without increasing Work Input.

At the bottom of the lever's 318 rotation, the fluid seesaw effect is used again but this time to shift the additional fluid mass away from the end of the lever 318 to return the system 310 back into its rotationally balanced state to reduce the work needed to return the system 310 back to its starting position.

As previously discussed, to return the system 310 to an original starting position, or another desired position, a counterweight (not shown) may be used. The counterweight may also be designed as a dynamic counterweight, such as an additional communicating vessel (not shown), which has a mass or fluid mass great enough to lift the lever 318 back to its starting position, but not so heavy as to interfere or stop Vadditional from rotating the lever 318 downward. All such designs are within the scope of the present disclosure.

With one or more of these techniques, the system 310 may be returned back to its starting position, such as is shown in FIG. 13. The Work Input needed to return the system 310 back to its starting position was reduced because the additional fluid molecules that were present in container 340, quantified as Vadditional, reverted back into the system 310 which then achieves rotational balance. For instance, the Vadditional fluid, or an equally corresponding quantity of fluid, exit container 340, move into the interconnecting conduit 330 of lever 318, causing an equal volume of fluid mass to move into container 312. This movement of the fluid a short distance, akin to a fluid chain, can return the system 310 back to its rotationally balanced state allowing for less Work Input to lift the fluid molecules that made up, and will again make up, Vadditional 17 (FIG. 19), back to their starting height, so that the system 310 can again to engage in a new cycle of motion.

In general, the gravitational potential energy (GPE) of Vadditional is equal to the mass of Vadditional times the height Vadditional can fall, times the force of gravity. Assuming no change in gravity, in order to increase the GPE of Vadditional, the mass of Vadditional must be increased, and/or the height that Vadditional can fall must be increased. To increase the amount of mass of Vadditional, one would need to increase the amount of fluid displaced in the holding tank 420 which would increase the Work Input. However, because of the fluid seesaw effect, to increase the height that Vadditional can fall above some zero point, requires only an increase in the starting fluid column heights of the fluid in containers 312, 340 and the elongation and rebalancing of the system 310, which does not require an increase of Work Input.

The system 310 uses the greater GPE of a Vadditional created at the top of a taller starting fluid column to increase the possible Work Output of the system 310 without increasing Work Input. In the most elementary physics explanation, Work Input is the work needed to lift the fluid mass that resides above the holding tank, and Work Output is the distance the fluid mass of Vadditional 17 can fall, with the gap between Work Input and Work Output made possible by the offsetting fluid column pressures, an Energy Transfer, and the fluid chain shift in the system 310, all of which is encompassed in the fluid seesaw effect.

FIG. 20 is a schematic front view illustration of a fluid communicating vessel with an output thereof, in accordance with the present disclosure. The Work Output of the system 310 may be used for any purpose desired. For instance, in one example, the system 310 may utilize a rotatable shaft 390 or output shaft which is positioned to receive rotational motion from axis 334, or otherwise mechanically connected to the system 310 to receive rotational motion. The rotatable shaft 390 can be used, for instance, to provide rotational energy to an electrical generator 392 which can convert the rotational energy into electrical energy. Similarly, the rotatable shaft 390 can be used to output rotational energy to other devices 394, such as to any mechanical system, e.g., industrial machinery, water pumps, or the like.

The system 310 of FIGS. 12-20 may also be modified and arranged such that multiple systems 310 can be ganged together in a rotationally balanced structure which can undergo repeated 360-degree rotations, like a continually rotating wheel, rather than just see-saw like movements. For instance, this design may utilize a mechanical coupler or driveshaft, where the mechanical coupler or driveshaft may connect two or more systems 310 together to allow multiple systems 310 to operate to rotate an output shaft and generate a greater output energy. It is noted that any number of systems 310 may be used in a rotationally balanced manner, which allows for one system 310 to effectively offset an opposing system 310, due to the opposite angles of the interconnecting lever conduits being rotationally balanced. This type of design of the system 310 may have certain advantages over a system 310 which is configured to only undergo see-saw like movements, as the see-saw design requires the system to stop and start again at the top and bottom of the rotation of the lever 318, whereas the system 310 can operate continuously in 360-degree rotational movement.

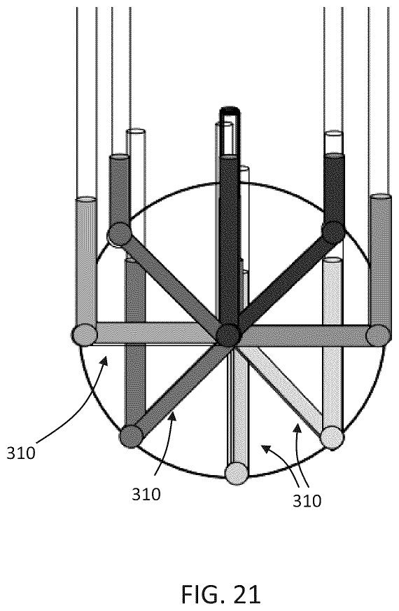

FIG. 21 is a schematic front view illustration of a ganged fluid communicating vessel, in accordance with the present disclosure. With reference to FIG. 20, using multiple systems 310, each having two containers, and arranging them into a Ferris wheel type of arrangement with each container 340 of each system 310 having a mirror opposite container 340 may alleviate the need for container 384 and its rod 382 to maintain rotational balance of the system 310. It is understood that such a Ferris wheel type of arrangement would not be rotationally balanced at each position in its rotation. Adding multiple systems 310 would improve the rotational balance of the wheel until, at some number of systems 310 making up the Ferris wheel design, the arrangement would be rotationally balanced to sufficiently operate. In particular, operation could be achieved without the use of fluid rod and tank components, as used in other embodiments.

Using multiple systems 310 in a Ferris wheel arrangement, Work Input would be added to increase the volume of air in a particular systems'310 holding tank 420 as its container 340 rotated past the 12 o'clock position, creating Vadditional 17 in container 340 when that system 310's container 340 was at the top of its rotation. And, air would be moved out of that system 310's holding tank 420 as its container 340 arrived at the bottom of its rotation, say the 6 'clock position, to remove Vadditional 17 from the end of lever 318 of that system 310. Accordingly, this design would effectively create an unbalanced wheel where each container 340 on one side of the rotations, e.g., the 12 o'clock to 6 o'clock side, would contain an additional volume of fluid as compared to the other side of the rotation, e.g., the 6 o'clock to 12 o'clock side of the rotation. This, in turn, allows the system 310 to operate efficiently and continuously, which provides for a greater energy output than other systems.

There are, of course, other designs where different dimensions of these structures may be used or chosen, and where the GPE achieved from Vadditional is less than a possible maximum, but still achieves operational parameters of the system 310, all of which are considered within the scope of the present disclosure. For instance, there may be spatial parameters which dictate the practical size of the containers 340 or the lever 318, such as the footprint of an installation location. There are also situations where less than the maximum possible GPE may be used in order to prevent the system 310 from reaching an undesirable position, such as where one container is located to fully drain all fluid into another container and runs dry.

As previously noted, and as depicted in FIGS. 13-17, before any air is adjusted in the holding tank 420 of container 312, and thus, before there is any shift of fluid mass in the system 310, the system 310 is rotationally balanced at each position in its rotation. A rotationally balanced system can be achieved with a precise spatial arrangement of the components of the system 310 to achieve balance about the axis 334 of rotation, whereby unbalancing of the system 310, or disrupting the balance, can be precisely achieved through the introduction of changes in fluid pressure into the system 310.

It is noted that the system 310 described herein may be implemented with various constructions or additional components beyond those described relative to FIGS. 1-21, all of which are considered within the scope of the present disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described herein as acting in certain combinations and even initially claimed as such, one or more features from a claimed combination can in some cases be excised from the combination, and the claimed combination may be directed to a sub-combination or variation of a sub-combination. Particular embodiments of the subject matter have been described. Other embodiments are within the scope of the following claims.

What is claimed is:

1. An engine system with communicating fluid vessels, the engine system comprising:
an interconnecting lever conduit configured to rotate about an axis;
a first fluid container fluidically connected to the interconnecting lever conduit, the first fluid container positioned at or near the axis of the interconnecting lever conduit; and
a second fluid container fluidically connected to the interconnecting lever conduit, the second fluid container positioned at or near an end of the interconnecting lever conduit, wherein liquid fluid is movable between the first and second fluid containers through the interconnecting lever conduit,
wherein the interconnecting lever conduit with the first and second fluid containers is rotationally balanced about the axis, and wherein, a shift of fluid mass between the first and second fluid containers rotates the lever about the axis, thereby generating an energy output.

2. The engine system of claim 1, wherein the shift of fluid mass between the first and second fluid containers increases a height of at least one of the first or second fluid containers, thereby generating the energy output as a mechanical rotational force of the interconnecting lever conduit based on the increase in height.

3. The engine system of claim 1, wherein the shift of fluid mass increases a mass of the fluid in the second fluid container, thereby increasing a torque exerted on the axis the interconnecting lever conduit by the second fluid container.

4. The engine system of claim 1, further comprising:
at least one holding tank positioned in the first fluid container and coupled to a weight positioned at least partially in an outer tank;
at least one tether physically linking together the weight and the first fluid container;
at least one pulley positioned along a path of the at least one tether; and
a supply of a gas in fluid communication with an interior of the at least one holding tank,
wherein supplying the gas to the interior of the holding tank displaces a volume of fluid from the holding tank increasing a fluid column height of the liquid fluid in the first fluid container.

5. The engine system of claim 4, wherein the at least one tether further comprises two tethers, each of the two tethers connected, directly or indirectly, to the first fluid container and the weight.

6. The engine system of claim 4, further comprising a block and a shaft, wherein the block is connected to the holding tank and is sized to crowd out a surface area of the first fluid container.

7. The engine system of claim 4, wherein the fluid in the outer tank has a density that substantially matches a density of the weight.

8. The engine system of claim 4, wherein the supply of the gas is an air compressor.

9. The engine system of claim 4, wherein supplying gas to the interior of the holding tank generates a GPE difference between the first fluid container and the second fluid container, wherein the GPE difference generates the energy output.

10. The engine system of claim 1, wherein the interconnecting lever conduit is free from fluid containers beyond for the first fluid container and the second fluid container.

11. A method for generating an energy output using an engine system with communicating fluid vessels, the method comprising:
rotationally balancing an interconnecting lever conduit about an axis, the interconnecting lever conduit configured to rotate about the axis, wherein a first fluid container is fluidically connected to the interconnecting lever conduit and positioned at or near the axis of the interconnecting lever conduit, and wherein a second fluid container is fluidically connected to the interconnecting lever conduit and positioned at or near an end of the interconnecting lever conduit;
increasing a pressure in the first fluid container, thereby initiating a fluid chain effect to cause a shift of fluid mass from the first fluid container, through the interconnecting lever conduit, and to the second fluid container, thereby increasing a mass in the second fluid container;
using the increase of fluid mass in the second fluid container, rotating the interconnecting lever conduit about the axis, thereby generating a torque about the axis; and
outputting an energy output from the torque.

12. The method of claim 11, wherein the shift of fluid mass is independent of a starting fluid column height in the first or second fluid containers, and is independent of a length and an angle of the interconnecting lever conduit.

13. The method of claim 11, wherein the shift of fluid mass between the first and second fluid containers increases a height of fluid in at least one of the first or second fluid containers, thereby generating the energy output as a mechanical rotational force of the interconnecting lever conduit based on the height.

14. The method of claim 11, further comprising increasing the torque exerted on the axis of the interconnecting lever conduit by the second fluid container when the shift of fluid mass increases the mass of a liquid fluid in the second fluid container.

15. The method of claim 11, further comprising:
at least one holding tank positioned in the first fluid container and coupled to a weight positioned at least partially in an outer tank;
at least one tether physically linking together the weight and the first fluid container;
at least one pulley positioned along a path of the at least one tether; and
a supply of a gas in fluid communication with an interior of the at least one holding tank, wherein supplying the gas to the interior of the holding tank displaces a volume of fluid from the holding tank increasing the a fluid column height of a liquid fluid in the first fluid container.

16. The method of claim 15, wherein the at least one tether further comprises two tethers, each of the two tethers connected, directly or indirectly, to the first fluid container and the weight.

17. The method of claim 15, further comprising a block and a shaft, wherein the block is connected to the holding tank and is sized to crowd out a surface area of the first fluid container.

18. The method of claim 15, wherein the fluid in the outer tank has a density that substantially matches a density of the weight.

19. The method of claim 15, wherein the supply of the gas is an air compressor.

20. The method of claim 15, further comprising generating a GPE difference between the first fluid container and the second fluid container to generate the energy output when supplying gas to the interior of the holding tank.

21. The method of claim 11, wherein the interconnecting lever conduit is free from fluid containers beyond for the first fluid container and the second fluid container.

22. An engine system with communicating fluid vessels, the engine system comprising:
an interconnecting lever conduit configured to rotate about an axis;
a first fluid container fluidically connected to the interconnecting lever conduit, the first fluid container positioned at or near the axis of the interconnecting lever conduit; and
a second fluid container fluidically connected to the interconnecting lever conduit, the second fluid container positioned at or near an end of the interconnecting lever conduit, wherein liquid fluid is movable between the first and second fluid containers using the interconnecting lever conduit, and wherein the interconnecting lever conduit with the first and second fluid containers is rotationally balanced about the axis;
at least one holding tank positioned in the first fluid container and coupled to a weight positioned at least partially in an outer tank, the outer tank having a fluid therein;
at least two tethers physically linking together the weight and the first fluid container;
a plurality of pullies positioned along a path of the at least two tethers; and
a supply of a gas that is in fluid communication with an interior of the at least one holding tank,
wherein supplying the gas to the interior of the holding tank displaces a volume of fluid from the holding tank increasing a fluid column height of the liquid fluid in the first fluid container,
thereby causing a shift of fluid mass between the first and second fluid containers which rotates the lever about the axis, thereby generating an energy output.

23. The engine system of claim 22, wherein the shift of fluid mass between the first and second fluid containers increases a height of fluid in at least one of the first or second fluid containers, thereby generating the energy output as a mechanical rotational force of the interconnecting lever conduit based on the height.

24. The engine system of claim 22, wherein the shift of fluid mass increases a mass of the fluid in the second fluid container, thereby increases a torque exerted on an axis the interconnecting lever conduit by the second fluid container.
